(19) United States
(12) Patent Application Publication
(10) Pub. No.: US 2026/0233521 A1
(43) Pub. Date: Aug. 13, 2026

(54) LIQUID EJECTING HEAD AND LIQUID EJECTING APPARATUS

(71) Applicant: SEIKO EPSON CORPORATION, Tokyo (JP)

(72) Inventor: Yuichi KATANIWA, SHIOJIRI-SHI (JP)

(21) Appl. No.: 19/533,569

(22) Filed: Feb. 9, 2026

(30) Foreign Application Priority Data
Feb. 10, 2025 (JP) 2025-020342

(51) Int. Cl. B41J 2/14; B41J 2/175

(52) U.S. Cl. CPC B41J 2/14233; B41J 2/17563; B41J 2002/14306; B41J 2002/14419; B41J 2002/14491

(57) ABSTRACT

A liquid ejecting head includes a nozzle plate, a flow path substrate having a first-flow-path, a flow path forming substrate, a drive element, a protective substrate, and a case member disposed in a second-direction of the flow path substrate and having a second-flow-path communicating with the first-flow-path, in which a first-surface of the flow path substrate that faces the second-direction and on which the first-flow-path opens, and a second-surface of the case member that faces the first-direction and on which a second-flow-path opens are disposed with a gap, the first-flow-path and the second-flow-path are communicated with each other in a liquid-tight manner by an adhesive disposed in the gap, and an upper surface of the protective substrate and a lower surface of the case member are in contact with each other without being adhered to each other.

The present application is based on, and claims priority from JP Application Serial Number 2025-020342, filed February 10, 2025, the disclosure of which is hereby incorporated by reference herein in its entirety.

### BACKGROUND

### 1. Technical Field

The present disclosure relates to a liquid ejecting head and a liquid ejecting apparatus that eject liquid from nozzles, and particularly to an ink jet recording head and an ink jet recording apparatus that discharge ink as liquid.

### 2. Related Art

A liquid ejecting head includes a plurality of head chips that eject liquid, a fixing plate to which the plurality of head chips are fixed, and a holder that holds the plurality of head chips between the holder and the fixing plate. The head chip includes a nozzle plate having nozzles formed therein for ejecting liquid droplets, a communication plate for supplying liquid to the nozzles, a pressure chamber substrate provided with a pressure chamber communicating with the nozzles, a drive element provided on the pressure chamber substrate via a diaphragm, a protective substrate disposed above the pressure chamber substrate, and a case provided above the communication plate. Such a liquid ejecting head ejects liquid droplets from the nozzles by generating a pressure change in the liquid within the pressure chamber due to the driving of the drive element (for example, see JP-A-2023-83724).

In a liquid ejecting head in the related art, a gap is provided between an upper surface of a protective substrate and a lower surface of a case so that the protective substrate and the case are not adhered to each other, in order to prevent an influence of deformation of the case, which is caused by a difference in linear expansion coefficients between the protective substrate and the case, from being transmitted to the protective substrate. However, when an external force is applied to the liquid ejecting head in a direction opposite to a liquid ejecting direction, due to contact of a medium with a nozzle plate or a fixing plate of the liquid ejecting head, for example due to a medium transport failure, there is a problem that a fixing plate deforms with a part fixed to a holder of the fixing plate as a fulcrum, or the nozzle plate is pushed upward, causing the protective substrate to be displaced with respect to the case to fill the gap, which leads to damage of the substrates constituting the liquid ejecting head.

### SUMMARY

According to an aspect of the present disclosure, there is provided a liquid ejecting head including a nozzle plate having a plurality of nozzles for ejecting liquid in a first direction, a flow path substrate laminated on the nozzle plate in a second direction opposite to the first direction and having a first flow path communicating with the plurality of nozzles, a flow path forming substrate laminated on the flow path substrate in the second direction and having a pressure chamber, a drive element provided on a surface of the flow path forming substrate facing the second direction, a protective substrate laminated on the flow path forming substrate and accommodating the drive element, and a case disposed in the second direction with respect to the flow path substrate and having a second flow path communicating with the first flow path, in which a first surface of the flow path substrate that faces the second direction and on which the first flow path opens, and a second surface of the case that faces the first direction and on which the second flow path opens, are disposed in the first direction with a gap, the first flow path and the second flow path are communicated with each other in a liquid-tight manner by an adhesive disposed in the gap, and an upper surface of the protective substrate facing the second direction and a lower surface of the case facing the first direction are in contact with each other without being adhered to each other.

Further, according to another aspect of the present disclosure, there is provided a liquid ejecting apparatus including the liquid ejecting head described in the above aspect, and a liquid storage portion for storing liquid to be supplied to the liquid ejecting head.

### BRIEF DESCRIPTION OF THE DRAWINGS

FIG. 1 is a cross-sectional view of a liquid ejecting head according to Embodiment 1.

FIG. 2 is an exploded perspective view of a head chip according to Embodiment 1.

FIG. 3 is a plan view of a pressure chamber substrate according to Embodiment 1.

FIG. 4 is a cross-sectional view of a main part of a head chip and a fixing plate according to Embodiment 1.

FIG. 5 is a cross-sectional view of a main part of a head chip and a fixing plate according to Embodiment 2.

FIG. 6 is a cross-sectional view of a main part of a head chip and a fixing plate relating to Modification Example 1 of Embodiment 2.

FIG. 7 is a cross-sectional view of a main part of a head chip and a fixing plate relating to Modification Example 2 of Embodiment 2.

FIG. 8 is a cross-sectional view of a main part of a head chip and a fixing plate according to Modification Example 3 of Embodiment 2.

FIG. 9 is a cross-sectional view of a head chip and a fixing plate according to Embodiment 3.

FIG. 10 is a cross-sectional view of a main part of a head chip and a fixing plate according to Embodiment 4.

FIG. 11 is a plan view of a case according to another embodiment.

FIG. 12 is a cross-sectional view of a main part of a head chip and a fixing plate according to another embodiment.

FIG. 13 is a view illustrating a schematic configuration of a liquid ejecting apparatus according to an embodiment.

### DESCRIPTION OF EMBODIMENTS

The present disclosure will be described in detail below based on embodiments. However, the following description shows one aspect of the present disclosure, and can be modified as desired within the scope of the present disclosure. In each drawing, the same reference numerals indicate the same members, and the description thereof will be omitted as appropriate. In addition, in each drawing, X, Y, and Z represent three spatial axes that are orthogonal to each other. In the present specification, directions along these axes will be referred to as X directions, Y directions, and Z directions. In each drawing, a direction indicated by an arrow is a positive (+) direction, and a direction opposite to the arrow is a negative (-) direction. The Z direction indicates a vertical direction, the +Z direction indicates a vertically downward direction, and the -Z direction indicates a vertically upward direction. Furthermore, directions along the three spatial axes of which the positive direction and the negative direction are not limited will be referred to as an X-axis direction, a Y-axis direction, and a Z-axis direction.

### Embodiment 1

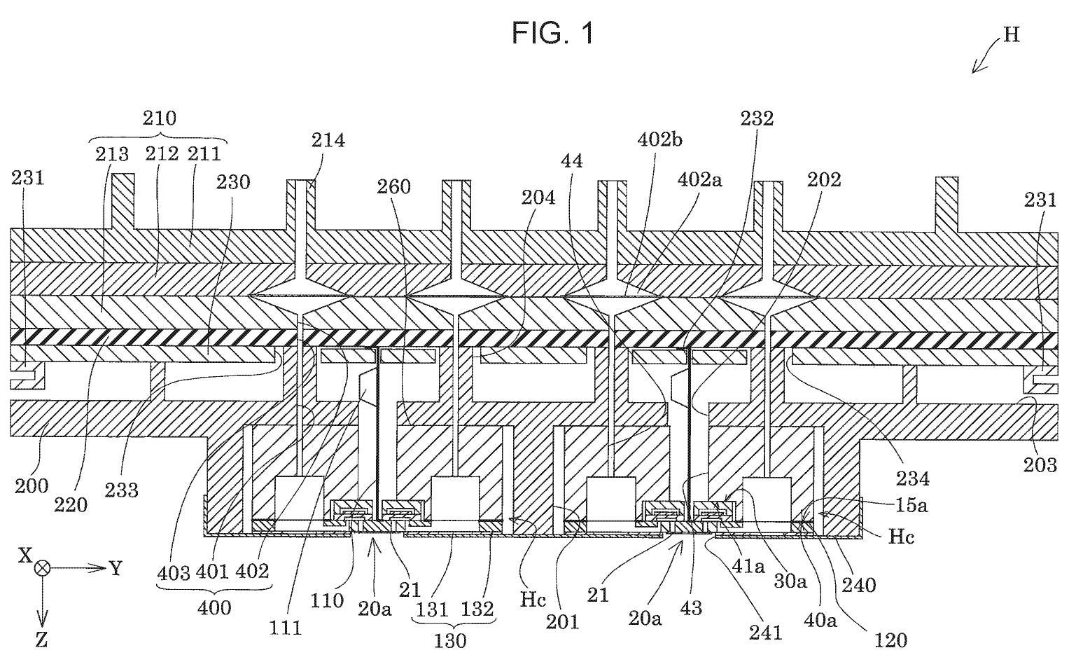

FIG. 1 is a cross-sectional view of a liquid ejecting head H according to Embodiment 1 of the present disclosure.

As illustrated in FIG. 1, the liquid ejecting head H includes a head chip Hc, a holder 200, a coupling flow path member 210, a seal member 220, a relay substrate 230, and a fixing plate 240.

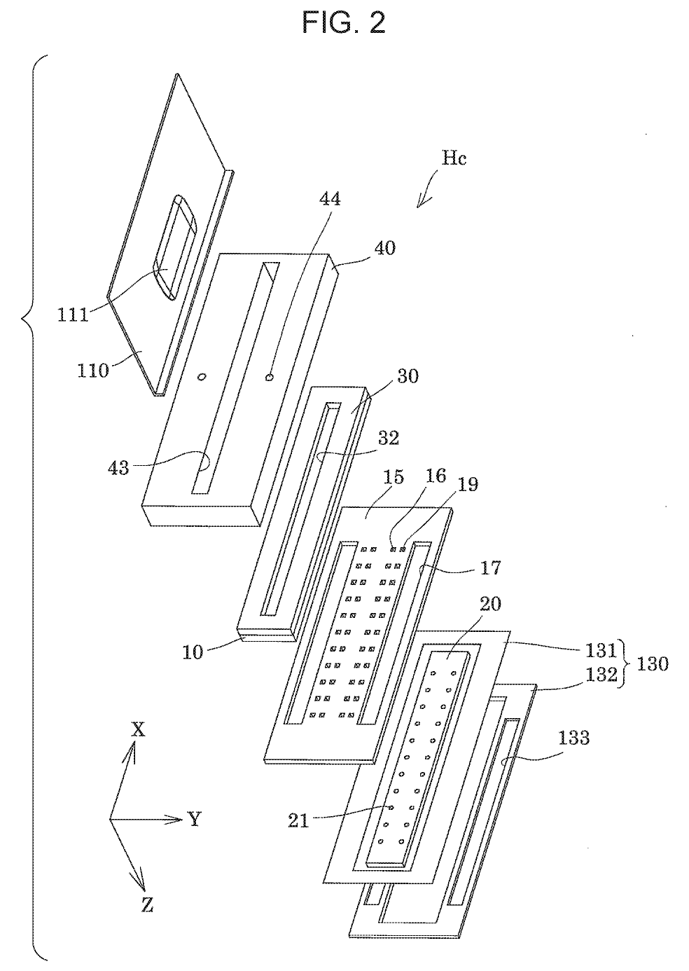

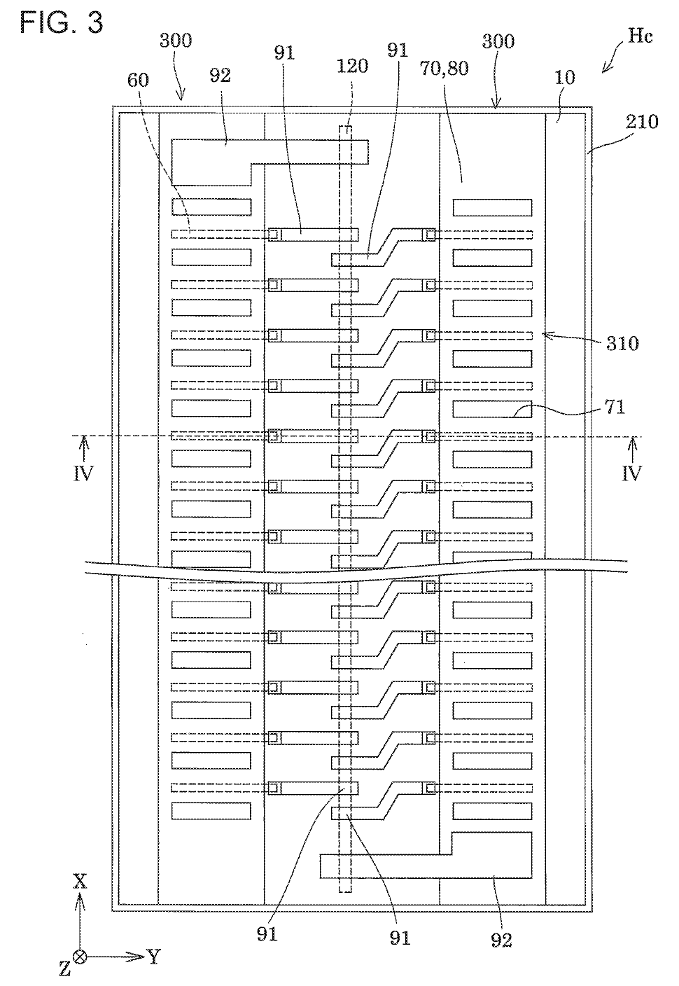

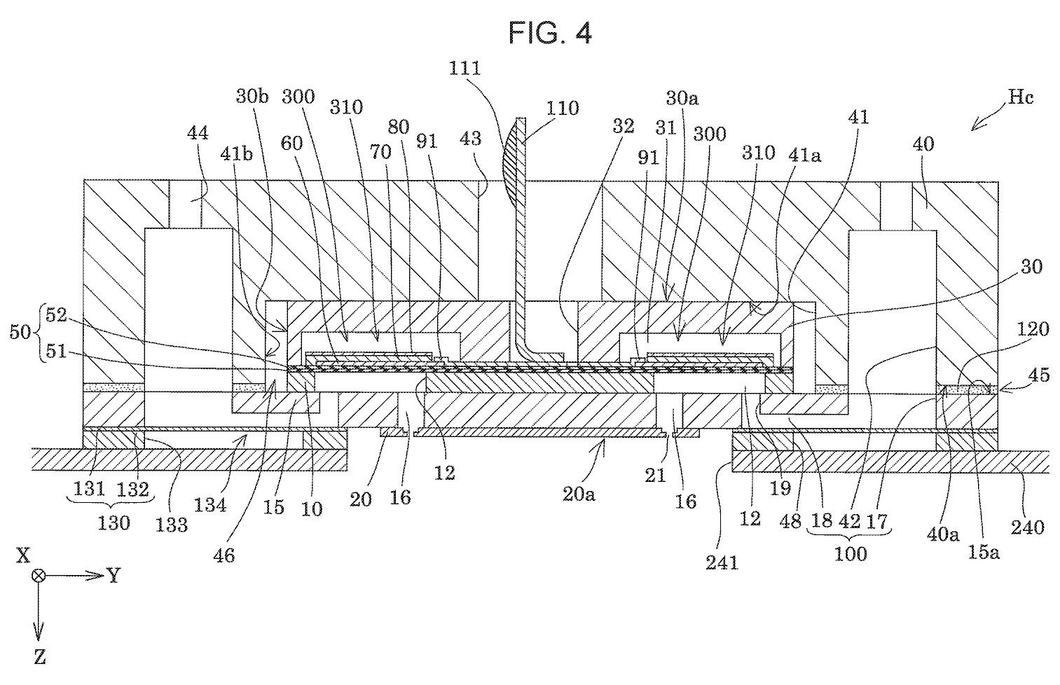

First, a head chip 8 of the present embodiment will be described. FIG. 2 is an exploded perspective view of the head chip Hc according to Embodiment 1 of the present disclosure. FIG. 3 is a plan view of a pressure chamber substrate 10 of the head chip Hc when viewed in the +Z direction. FIG. 4 is a cross-sectional view of a main part of the head chip Hc and the fixing plate 240 taken along the line IV-IV in FIG. 3. In FIG. 3, a piezoelectric actuator 300 is also illustrated.

As illustrated, the head chip Hc of the present embodiment includes the pressure chamber substrate 10, a communication plate 15, a nozzle plate 20 having a plurality of nozzles 21 formed therein, a protective substrate 30, a case member 40, the piezoelectric actuator 300, and a flexible substrate 110.

The pressure chamber substrate 10 is made of, for example, a silicon substrate, a glass substrate, an SOI substrate, or various ceramic substrates. In the pressure chamber substrate 10, a plurality of pressure chambers 12 are disposed side by side along the X-axis direction. The plurality of pressure chambers 12 are disposed on a straight line along the X-axis direction such that positions in the Y-axis direction are the same. Two pressure chambers 12 adjacent to each other in the X-axis direction are partitioned by a partition wall. In the present embodiment, two pressure chamber rows, in which the pressure chambers 12 are disposed side by side along the X-axis direction, are provided in the Y-axis direction.

On a surface of the pressure chamber substrate 10 facing the +Z direction, the communication plate 15 and the nozzle plate 20 are sequentially laminated in the +Z direction. On a surface of the pressure chamber substrate 10 facing the -Z direction, a diaphragm 50 and the piezoelectric actuator 300 are sequentially laminated in the -Z direction.

The communication plate 15 is made of a plate-shaped member joined to a surface of the pressure chamber substrate 10 facing the +Z direction. The communication plate 15 is provided with a nozzle communication path 16 that makes the pressure chamber 12 and the nozzle 21 communicate with each other. Further, the communication plate 15 is provided with a first manifold portion 17 and a second manifold portion 18, which constitute a part of a manifold 100 that serves as a common liquid chamber to which the plurality of pressure chambers 12 commonly communicate. The first manifold portion 17 is provided to penetrate the communication plate 15 in the Z-axis direction. Further, the second manifold portion 18 is provided to be open on the surface facing the +Z direction without penetrating the communication plate 15 in the Z-axis direction. Furthermore, the communication plate 15 is provided with a supply communication path 19 that communicates with one end portion of the pressure chamber 12 in the Y-axis direction, independently for each pressure chamber 12. The supply communication path 19 communicates between the second manifold portion 18 and the pressure chambers 12 to supply the ink in the manifold 100 to the pressure chambers 12. That is, the head chip Hc of the present embodiment includes the supply communication path 19, the pressure chamber 12, and the nozzle communication path 16 as individual flow paths communicating with the nozzle 21. As such a communication plate 15, a silicon substrate and an SOI substrate are preferably used. The material of the communication plate 15 is not limited thereto, and a glass substrate, various ceramic substrates, a metal substrate such as a stainless steel substrate, or the like may be used.

The nozzle plate 20 is a plate-shaped member joined to a side of the communication plate 15 opposite to the pressure chamber substrate 10, that is, a surface facing the +Z direction. The nozzle plate 20 has a plurality of nozzles 21 formed therein, which communicate with each of the pressure chambers 12 through the nozzle communication path 16. In the present embodiment, the plurality of nozzles 21 are disposed side by side in a row along the X-axis direction. In the present embodiment, two nozzle rows, in which the nozzles 21 are disposed side by side along the X-axis direction, are provided spaced apart in the Y-axis direction. As such a nozzle plate 20, a silicon substrate or an SOI substrate is preferably used. The material of the nozzle plate 20 is not limited thereto, and a glass substrate, various ceramic substrates, a metal substrate such as a stainless steel substrate, or an organic material such as polyimide resin may be used. In the present embodiment, a surface of the nozzle plate 20 facing the +Z direction, where the nozzles 21 open is referred to as a nozzle surface 20a.

The diaphragm 50 has, for example, an elastic film 51 made of silicon oxide provided on the pressure chamber substrate 10 side, and an insulator film 52 made of zirconium oxide disposed on the surface of the elastic film 51 facing the -Z direction. The pressure chamber substrate 10 may be etched in the -Z direction from the +Z direction facing surface thereof to form a recessed portion as the pressure chamber 12. In this case, since a bottom surface of the recessed portion serves as the elastic film 51, the pressure chamber substrate 10 and the elastic film 51, which is a part of the diaphragm 50, are integrally formed. Further, the entire diaphragm 50 and the pressure chamber substrate 10 may be integrally formed.

The piezoelectric actuator 300 includes a first electrode 60, a piezoelectric layer 70, and a second electrode 80 that are sequentially laminated on the diaphragm 50 in the -Z direction. Such a piezoelectric actuator 300 is also called a piezoelectric element, and refers to a part including the first electrode 60, the piezoelectric layer 70, and the second electrode 80. In addition, a part where piezoelectric strain occurs in the piezoelectric layer 70 when a voltage is applied between the first electrode 60 and the second electrode 80 is referred to as an active portion 310. Meanwhile, a part where piezoelectric strain does not occur in the piezoelectric layer 70 is referred to as an inactive portion. That is, the active portion 310 refers to a part where the piezoelectric layer 70 is interposed between the first electrode 60 and the second electrode 80. In the present embodiment, the active portion 310 is formed for each pressure chamber 12. That is, a plurality of active portions 310 are disposed side by side in the X-axis direction in the piezoelectric actuator 300. The plurality of active portions 310 serve as drive elements that cause a pressure change in the ink in the pressure chamber 12. In general, one of the electrodes of the active portion 310 is configured as an independent individual electrode for each active portion 310, and the other electrode is configured as a common electrode common to the plurality of active portions 310. In the present embodiment, the first electrode 60 is configured as an individual electrode, and the second electrode 80 is configured as a common electrode. It is needless to say that the first electrode 60 may form a common electrode, and the second electrode 80 may form an individual electrode. Further, in the piezoelectric actuator 300, a part of the pressure chamber 12 facing the Z-axis direction serves as a flexible portion, and an outer part of the pressure chamber 12 not facing the Z-axis direction serves as a non-flexible portion.

Further, as illustrated in FIGS. 3 and 4, an individual lead electrode 91, which is a lead wiring, is drawn out from the first electrode 60 of the piezoelectric actuator 300. Also, a common lead electrode 92, which is a lead wiring, is drawn out from the second electrode 80. The flexible substrate 110, which is a flexible substrate, is coupled to end portions of the individual lead electrode 91 and the common lead electrode 92 opposite to end portions coupled to the piezoelectric actuator 300. The flexible substrate 110 is mounted with a drive circuit 111 having a plurality of switching elements that select whether to supply a drive signal for driving each of the active portions 310 to each active portion 310. That is, the flexible substrate 110 in the present embodiment is a chip on film (COF). The flexible substrate 110 may not be provided with the drive circuit 111. That is, the flexible substrate 110 may be a flexible flat cable (FFC), a flexible printed circuit (FPC), or the like.

The protective substrate 30 having substantially the same size as the pressure chamber substrate 10 is joined to the surface of the pressure chamber substrate 10 facing the -Z direction. The protective substrate 30 has an accommodation portion 31 which is a space for protecting the piezoelectric actuator 300. An accommodation portion 31 is independently provided for each row of the active portions 310 disposed side by side in the X-axis direction, and two accommodation portions 31 are disposed side by side in the Y-axis direction. Further, the protective substrate 30 has a coupling port 32, which is an opening portion penetrating in the Z-axis direction, between the two accommodation portions 31 disposed side by side in the Y-axis direction. End portions of the individual lead electrode 91 and the common lead electrode 92 drawn out from each electrode of the piezoelectric actuator 300 are extended to be exposed within the coupling port 32, and the individual lead electrode 91, the common lead electrode 92, and the flexible substrate 110 are electrically coupled within the coupling port 32. As such a protective substrate 30, a silicon substrate or an SOI substrate is preferably used. The material of the protective substrate 30 is not limited thereto, and a glass substrate, various ceramic substrates, a metal substrate such as a stainless steel substrate, or the like may be used.

The case member 40 is laminated on the communication plate 15 in the -Z direction. The case member 40 has substantially the same outer peripheral shape as the communication plate 15 when viewed in the Z-axis direction.

The case member 40 has a recessed portion 41 in which an assembly of the pressure chamber substrate 10 and the protective substrate 30 is accommodated. The recessed portion 41 is provided to open on a surface of the case member 40 facing the +Z direction.

The case member 40 has a third manifold portion 42 communicating with the first manifold portion 17 of the communication plate 15. The third manifold portion 42 has a recessed shape that opens on surfaces facing the +Z direction on both sides of the recessed portion 41 in the Y-axis direction. The manifold 100 of the present embodiment is configured with the first manifold portion 17 and the second manifold portion 18 provided on the communication plate 15, and the third manifold portion 42 provided on the case member 40. The manifold 100 is provided for each nozzle row. Further, the case member 40 is provided with an inlet 44 for communicating with a -Z direction bottom surface of the third manifold portion 42 and supplying ink to each manifold 100.

A lower surface 41a of case member 40 facing the +Z direction and an upper surface 30a of protective substrate 30 facing the -Z direction are provided in contact with each other without being adhered. The lower surface 41a of the case member 40 facing the +Z direction is, in the present embodiment, a bottom surface located in the -Z direction among inner surfaces of the recessed portion 41. Here, "two surfaces are in contact" means that at least a part of the two surfaces is in contact. That is, both a configuration in which the two surfaces are in point contact at one or a plurality of points, and a configuration in which the two surfaces are in surface contact are included.

Further, a first surface 15a of the communication plate 15 facing the -Z direction, where the first manifold portion 17 opens, and a second surface 40a of the case member 40 facing the +Z direction, where the third manifold portion 42 opens, are disposed in the Z-axis direction with a gap 45. The first surface 15a of the communication plate 15 facing the -Z direction, where the first manifold portion 17 opens, is, in the present embodiment, the surface of the communication plate 15 located foremost in the -Z direction. The second surface 40a of the case member 40 facing the +Z direction, where the third manifold portion 42 opens, is, in the present embodiment, the surface of the case member 40 located foremost in the +Z direction, and is a surface provided to surround the recessed portion 41 when the case member 40 is viewed in the -Z direction. The first surface 15a of the communication plate 15 and the second surface 40a of the case member 40 are adhered to each other via an adhesive 120. That is, the first manifold portion 17 and the third manifold portion 42 are communicated with each other in a liquid-tight manner by the adhesive 120 disposed in the gap 45 between the first surface 15a and the second surface 40a. In other words, the adhesive 120 is disposed in the gap 45 so as to surround the entire circumference of an opening of the first manifold portion 17 formed on the first surface 15a when viewed in the +Z direction, and also to surround the entire circumference of an opening of the third manifold portion 42 formed on the second surface 40a when viewed in the -Z direction. As such an adhesive 120, an adhesive with high resistance to liquid used in the head chip Hc, that is, an adhesive with high liquid resistance, such as an epoxy-based adhesive, is used. Further, it is preferable to use the adhesive 120 having a viscosity that allows the gap 45 to be filled before curing, and the adhesive has relatively little curing shrinkage. That is, when the viscosity of the adhesive 120 before curing is too low, the adhesive 120 tends to flow out from the gap 45, which is not preferable. Also, when the adhesive 120 with relatively large curing shrinkage is used, the first manifold portion 17 and the third manifold portion 42 cannot be coupled in a liquid-tight manner due to the curing shrinkage of the adhesive 120, which may cause ink leakage.

Here, "gap" refers to a gap between the first surface 15a and the second surface 40a at a part where the adhesive 120 is in contact with liquid in the flow path, and means a clearance of 1 μm or more. That is, when the gap is less than 1 μm, it is assumed that the first surface 15a of the communication plate 15 and the second surface 40a of the case member 40 are in contact. By the way, when a lower surface 41a of the recessed portion 41 and the upper surface 30a of the protective substrate 30 facing the -Z direction are abutted against each other, a depth of the recessed portion 41 is formed to a size where the gap 45 is disposed between the second surface 40a of the case member 40 and the first surface 15a of the communication plate 15. Therefore, it is preferable that the gap 45 is 50 μm or more, taking into account manufacturing errors of the case member 40 and the protective substrate 30. By setting the gap 45 50 μm or more, the gap 45 can be reliably formed between the first surface 15a and the second surface 40a even when manufacturing errors occur in the case member 40 or the protective substrate 30.

Further, in the present embodiment, an outer peripheral surface 30b of the pressure chamber substrate 10 and the protective substrate 30, that is, an end surface along the Z-axis direction of the pressure chamber substrate 10 and the protective substrate 30, is surrounded by an inner peripheral surface 41b of the recessed portion 41 of the case member 40, and the inner peripheral surface 41b of the recessed portion 41 of the case member 40 and the outer peripheral surface 30b of the pressure chamber substrate 10 and the protective substrate 30 are disposed with a gap 46 along an XY plane defined by an X-axis and a Y-axis. In the present embodiment, outer peripheral surfaces of the pressure chamber substrate 10 and the protective substrate 30 are flush, so these surfaces are collectively referred to as the outer peripheral surface 30b. Here, it is preferable that the gap 46 in the Y-axis direction between the inner peripheral surface 41b of the case member 40 and the outer peripheral surface 30b of the pressure chamber substrate 10 and the protective substrate 30 is larger than the gap 45 between the surface of the case member 40 and the surface of the communication plate 15 mentioned above. By making the gap 46 between the inner peripheral surface 41b of the case member 40 and the outer peripheral surface 30b of the pressure chamber substrate 10 and the protective substrate 30 larger than the gap 45 between the first surface 15a of the communication plate 15 and the second surface 40a of the case member 40, it is difficult for the adhesive 120 disposed in the gap 45 between the first surface 15a of the communication plate 15 and the second surface 40a of the case member 40 to be continuously disposed between the inner peripheral surface 41b and the outer peripheral surface 30b even when the adhesive 120 flows out into the gap 46. Therefore, adhesion between the inner peripheral surface 41b and the outer peripheral surface 30b can be suppressed. By the way, when the protective substrate 30 and the case member 40 are adhered, an influence of deformation of the case member 40, which is caused by a difference in linear expansion coefficients between the protective substrate 30 and the case member 40, is transmitted to the protective substrate 30, which may damage the piezoelectric actuator 300 on the diaphragm 50 adhered to the protective substrate 30. The pressure chamber substrate 10, the communication plate 15, the protective substrate 30, and the nozzle plate 20 are materials that have a smaller linear expansion coefficient than the case member 40 and are prone to cracking. In the present embodiment, by not adhering the case member 40 and the protective substrate 30, damage to the piezoelectric actuator 300 can be suppressed without transmitting the influence of deformation of the case member 40, which is caused by the difference in linear expansion coefficients between the protective substrate 30 and the case member 40, to the protective substrate 30.

Further, the case member 40 is provided with an opening portion 43 communicating with the coupling port 32 of the protective substrate 30 and through which the flexible substrate 110 is inserted. The opening portion 43 penetrates the case member 40 in the Z-axis direction, that is, the opening portion 43 is provided to open on the surface of the case member 40 facing the -Z direction and on the lower surface 41a of the recessed portion 41 on the -Z direction side. The flexible substrate 110, which is coupled to the individual lead electrode 91 and the common lead electrode 92 on the pressure chamber substrate 10, is led out to a surface side of the head chip Hc facing the -Z direction via the opening portion 43. The opening portion 43 has a width in the Y-axis direction larger than that of the coupling port 32 of the protective substrate 30 when viewed in the +Z direction.

As such a case member 40, for example, metal or resin is used.

Further, a compliance substrate 130 is provided on the surface of the communication plate 15 facing the +Z direction where the first manifold portion 17 and the second manifold portion 18 open. This compliance substrate 130 seals openings of the first manifold portion 17 and the second manifold portion 18 on the +Z direction side. In the present embodiment, the compliance substrate 130 includes a sealing film 131 made of a flexible thin film, and a fixing substrate 132 made of a hard material such as metal. A region of the fixing substrate 132 facing the manifold 100 is a compliance opening portion 133 completely removed in a thickness direction, and one surface of the manifold 100 is a compliance portion 134 sealed only with the flexible sealing film 131.

In such a head chip Hc, the liquid is taken in from the inlet 44, and the inside of the flow path from the manifold 100 to the nozzle 21 is filled with the ink. Thereafter, in accordance with a signal from the drive circuit 111, a voltage is applied to each active portion 310 corresponding to the pressure chamber 12, thereby deflecting and deforming the diaphragm 50 together with the piezoelectric actuator 300. Thus, pressure of the liquid in the pressure chamber 12 increases, and liquid droplets are ejected from a predetermined nozzle 21.

As illustrated in FIG. 1, the holder 200, the coupling flow path member 210, and the seal member 220 have a flow path 400 for supplying ink supplied from a liquid storage portion (not illustrated) to the head chip Hc.

The holder 200, the seal member 220, and the coupling flow path member 210 are laminated in the -Z direction in this order. The holder 200 has a first flow path 401, the coupling flow path member 210 has a second flow path 402, and the first flow path 401 and the second flow path 402 are coupled in a liquid-tight state by the seal member 220.

In the present embodiment, the coupling flow path member 210 is configured with three members 211, 212, and 213 laminated in the +Z direction in this order. The coupling flow path member 210 has a flow path coupling portion 214 that is coupled directly or via a supply tube or the like to a liquid storage portion (not illustrated) in which ink, which is liquid, is stored. In the present embodiment, as the flow path coupling portion 214, a portion that cylindrically protrudes in the -Z direction on the surface of the coupling flow path member 210 in -Z direction is provided. Inside such a flow path coupling portion 214, the second flow path 402 for supplying ink from the liquid storage portion is provided.

The second flow path 402 is configured with a flow path extending in the Z-axis direction, a flow path extending along a laminated interface of laminated members, or the like. Further, in the middle of the second flow path 402, a filter chamber 402a, whose inner diameter is wider and expanded than other regions, is provided, and within the filter chamber 402a, a filter 402b for catching foreign matter such as dust and air bubbles contained in ink is provided.

In the present embodiment, one coupling flow path member 210 includes four flow path coupling portions 214. The second flow path 402 may branch into two or more, for example, downstream of the filter 402b.

The holder 200 has the first flow path 401 communicating with each of the second flow paths 402 of the coupling flow path member 210. That is, the holder 200 has four first flow paths 401. The first flow path 401 and the second flow path 402 are coupled in a liquid-tight manner via the seal member 220. The seal member 220 has liquid resistance to liquid such as ink used in the liquid ejecting head H, and an elastically deformable material, for example, rubber, elastomer or the like may be used. Such a seal member 220 is provided with a communication flow path 403 penetrating in the Z-axis direction, and the first flow path 401 and the second flow path 402 communicate via the communication flow path 403. That is, the flow path 400, which is a supply flow path of the holder 200, includes the first flow path 401, the second flow path 402, and the communication flow path 403.

Further, the head chip Hc is held on the surface of the holder 200 facing the +Z direction. Specifically, the holder 200 has a head chip accommodation portion 201 having a recessed shape that opens on a surface facing the +Z direction, and the head chip Hc is held within the head chip accommodation portion 201. In a liquid ejecting head 2 of the present embodiment, a plurality of, for example, two head chips Hc are held. In the present embodiment, the head chip accommodation portion 201 is independently provided for each head chip Hc. That is, the holder 200 has two head chip accommodation portions 201. It is needless to say that the head chip accommodation portion 201 may be commonly provided across a plurality of head chips Hc. The number of head chips Hc held by the liquid ejecting head 2 is not particularly limited thereto, and may be one, or a plurality of two or more. In the present embodiment, the two head chips Hc are disposed side by side in the Y-axis direction to be at the same position in the X-axis direction. It is needless to say that the disposition of the plurality of head chips Hc is not particularly limited to thereto, and may be, for example, disposed in a staggered pattern along the X-axis direction. Such a holder 200 is formed of metal or resin.

The first flow path 401 of the holder 200 communicates with each inlet 44 of the head chip Hc accommodated in the head chip accommodation portion 201.

Further, the holder 200 is provided with a wiring holding hole 202 for inserting the flexible substrate 110 of each head chip Hc. In the present embodiment, two wiring holding holes 202 are provided in total by being independently provided for each head chip Hc. The flexible substrate 110 of the head chip Hc is led out to the surface side of the holder 200 facing the -Z direction via the wiring holding hole 202.

Further, in the Z-axis direction, a relay substrate 230, to which flexible substrates 110 of the plurality of head chips Hc are commonly coupled, is provided between the seal member 220 and the coupling flow path member 210. The relay substrate 230 is made of a rigid, non-flexible substrate, and is mounted with wiring, electronic components, and the like (not illustrated). In the present embodiment, a connector 231 to which external wiring is coupled is illustrated as an electronic component. Print signals and the like for controlling the head chip Hc are input to the relay substrate 230 from external wiring via the connector 231, and supplied from the relay substrate 230 to each head chip Hc. An external wiring opening portion 203 for inserting external wiring coupled to the connector 231 is provided on a side wall of the holder 200 opposite to the connector 231. The external wiring is coupled to the connector 231 of the relay substrate 230 provided inside the holder 200 via the external wiring opening portion 203.

The relay substrate 230 is provided with a wiring insertion hole 232 for leading out the flexible substrate 110 of the head chip Hc to the surface side facing the -Z direction. Two wiring insertion holes 232 are provided in total, one for each head chip Hc.

Further, the relay substrate 230 is provided with a protrusion insertion hole 233 that penetrates in the Z-axis direction. A protrusion portion 204, in which the first flow path 401 is provided, is provided to protrude in the -Z direction on the surface of the holder 200 facing the -Z direction, and the protrusion portion 204 is inserted into the -Z direction side of the relay substrate 230 via the protrusion insertion hole 233, and is coupled to communication flow path 403.

Further, the fixing plate 240 is fixed to the surface of the holder 200 facing the +Z direction where the head chip accommodation portion 201 opens. The fixing plate 240, in the present embodiment, has a size to cover the two head chips Hc. The fixing plate 240 is independently provided with an exposure opening portion 241 for each head chip Hc, which exposes the nozzle 21 of the head chip Hc in the +Z direction. Ink is ejected in the +Z direction from the nozzle 21 exposed from the exposure opening portion 241. It is needless to say that the exposure opening portion 241 may be commonly provided for the plurality of head chips Hc. The fixing plate 240 is fixed to the surface of the fixing substrate 132 of the compliance substrate 130 of each head chip Hc facing the +Z direction to define a compliance space with the compliance portion 134, in which the compliance portion 134 is deformable." By providing the compliance space, the compliance portion 134 can be deformed, and the compliance portion 134 can mitigate pressure fluctuations within the manifold 100. The compliance space is opened to the atmosphere via an atmospheric release path (not illustrated).

In such a liquid ejecting head H, by coupling flow paths of the communication plate 15 and the case member 40 of the head chip Hc in a liquid-tight manner, that is, coupling the first manifold portion 17 and the third manifold portion 42 with the adhesive 120 provided in the gap 45, the case member 40 and the protective substrate 30 can be abutted without being adhered.

Here, as described above, for example, when an influence of case deformation, which is caused by a difference in linear expansion coefficients between the protective substrate 30 and the case member 40, is transmitted to the protective substrate 30, there is a risk of damaging the piezoelectric actuator 300 on the diaphragm 50 adhered to the protective substrate 30. For this reason, when a gap is provided between the protective substrate 30 and the case member 40 so that the protective substrate 30 and the case member 40 are not adhered to each other, an external force is applied to the liquid ejecting head H in the -Z direction, which is a direction opposite to an ink ejecting direction, when a medium contacts the nozzle surface 20a or the fixing plate 240 of the liquid ejecting head H due to a medium transport failure, so-called paper jam, or the like. At this time, the protective substrate 30 moves with respect to the case member 40 to fill the gap between the protective substrate 30 and the case member 40, with a part fixed to the holder 200 of the fixing plate 240 as a fulcrum, and the fixing plate 240 deforms. This may deform the communication plate 15 and cause the communication plate 15 to crack. By the way, even when the fixing plate 240 is thick and has high rigidity and is difficult to deform, when an external force in the -Z direction is applied to the nozzle plate 20, the nozzle plate 20 is pushed in the -Z direction, which may deform the communication plate 15 and cause the communication plate 15 to crack, as the protective substrate 30 moves with respect to the case member 40 to fill the gap between the protective substrate 30 and the case member 40. When the first surface 15a of the communication plate 15 and the second surface 40a of the case member 40 are adhered without the gap 45 provided therebetween, the gap between the protective substrate 30 and the case member 40 tends to be formed relatively large, taking into account manufacturing errors of each member.

In the present embodiment, by having the case member 40 and the protective substrate 30 abut against each other without being adhered, even when an external force in the -Z direction is applied to the fixing plate 240 and the nozzle plate 20, movement of the protective substrate 30 in the -Z direction is restricted by the case member 40. Therefore, by restricting the movement of the protective substrate 30, deformation of the communication plate 15 into a convex shape in the -Z direction can be reduced, and cracking of the communication plate 15 can be suppressed.

In the present embodiment, the +Z direction is an example of a "first direction", the -Z direction is an example of a "second direction", and the Y-axis direction is an example of a "third direction". The case member 40 is an example of a "case", and the communication plate 15 is an example of a "flow path substrate". That is, the flow path substrate refers to a part in the +Z direction from the gap 45. Further, the first manifold portion 17 is an example of a "first flow path", and the third manifold portion 42 is an example of a "second flow path". The pressure chamber substrate 10 and the diaphragm 50 are examples of a "flow path forming substrate".

### Embodiment 2

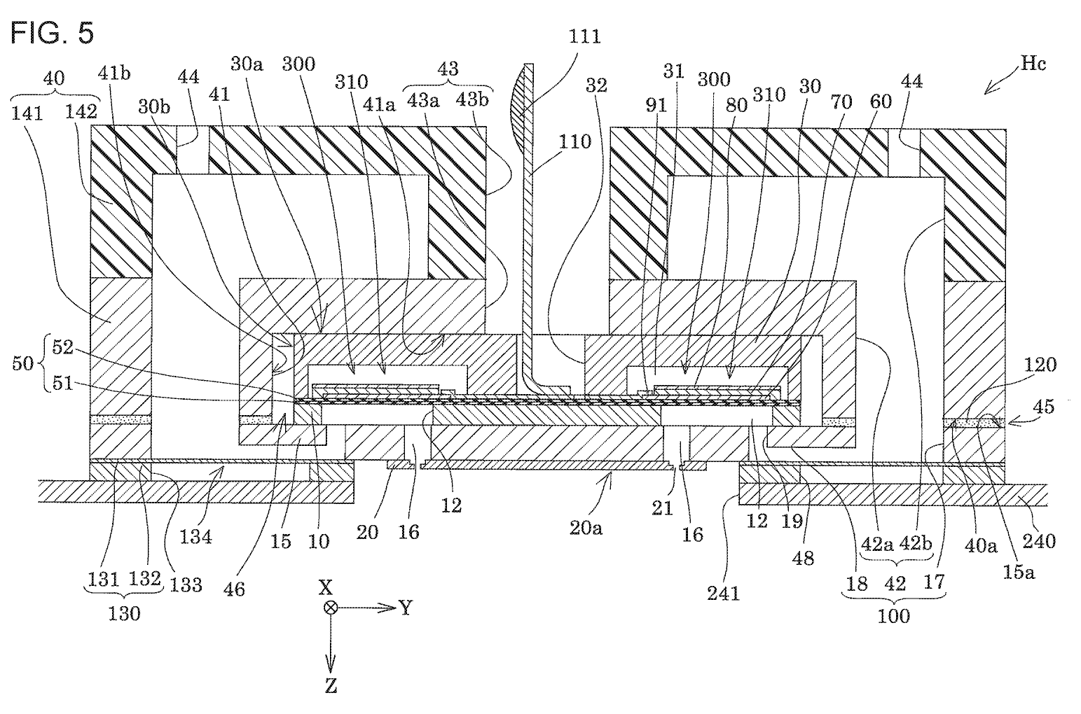

FIG. 5 is a cross-sectional view of a main part of the head chip Hc and the fixing plate 240 of a liquid ejecting head H according to Embodiment 2 of the present disclosure. Members that are the same as those in the above-described embodiment are denoted by the same reference numerals, and redundant descriptions are omitted.

As illustrated in FIG. 5, the head chip Hc of the liquid ejecting head H of the present embodiment includes the case member 40. The case member 40 includes a first case member 141 and a second case member 142. The first case member 141 and the second case member 142 are laminated in the -Z direction in this order.

The case member 40 is provided with a third manifold portion 42. In the present embodiment, the third manifold portion 42 includes a first part 42a provided on the first case member 141, and a second part 42b provided on the second case member 142.

The first part 42a is provided to penetrate the first case member 141 in the Z-axis direction.

The second part 42b has a recessed shape that opens on the surface of the second case member 142 facing the +Z direction. Further, the second part 42b is provided over a part overlapping the first part 42a to a part overlapping the protective substrate 30 when viewed in the Z-axis direction. That is, a width of the second part 42b in the Y-axis direction is larger than a width of the first part 42a in the Y-axis direction.

The first case member 141 and the second case member 142 are joined to each other by an adhesive (not illustrated), thermal welding, direct joining, or the like.

Such a case member 40, similarly to Embodiment 1 described above, has the first surface 15a of the communication plate 15 facing the -Z direction where the first manifold portion 17 opens, and the second surface 40a of the case member 40 facing the +Z direction where the third manifold portion 42 opens, which are disposed with the gap 45 in the Z-axis direction. The second surface 40a of the present embodiment is a surface facing the +Z direction where the first part 42a of the first case member 141 opens. The "gap" in the present embodiment is similar to "gap" in Embodiment 1 described above. The first surface 15a of the communication plate 15 and the second surface 40a of the case member 40 are adhered to each other via an adhesive 120. That is, the third manifold portion 42 and the first manifold portion 17 are communicated with each other in a liquid-tight manner by the adhesive 120 disposed in the gap 45 between the first surface 15a and the second surface 40a. Such an adhesive 120 uses the same type as the adhesive of Embodiment 1 described above.

Further, the case member 40 has the recessed portion 41 similar to Embodiment 1 described above. The recessed portion 41 is provided on the first case member 141 to open on the surface of the first case member 141 facing the +Z direction. The lower surface 41a of the case member 40 facing the +Z direction and the upper surface 30a of the protective substrate 30 facing the -Z direction are provided in contact with each other without being adhered. The lower surface 41a of the present embodiment is, similar to Embodiment 1 described above, a bottom surface facing the +Z direction among inner surfaces of the recessed portion 41 of the case member 40.

Further, the outer peripheral surface 30b of the pressure chamber substrate 10 and the protective substrate 30 is surrounded by the inner peripheral surface 41b of the recessed portion 41 of the case member 40, and the inner peripheral surface 41b of the recessed portion 41 of the case member 40 and the outer peripheral surface 30b of the pressure chamber substrate 10 and the protective substrate 30 are disposed with the gap 46 along the XY plane defined by the X-axis and the Y-axis. By providing the gap 46 between the inner peripheral surface 41b of the case member 40 and the outer peripheral surface 30b of the protective substrate 30 in this way, even when the adhesive 120 disposed in a gap 45 between the first surface 15a of the communication plate 15 and the second surface 40a of the case member 40 flows out into the gap 46 between the outer peripheral surface 30b and the inner peripheral surface 41b, it is difficult for the adhesive 120 to be disposed continuously between the inner peripheral surface 41b and the outer peripheral surface 30b, and adhesion between the inner peripheral surface 41b and the outer peripheral surface 30b can be suppressed. Therefore, by not adhering the case member 40 and the protective substrate 30, damage to the piezoelectric actuator 300 can be suppressed without transmitting an influence of deformation of the case member 40, which is caused by the difference in linear expansion coefficients between the protective substrate 30 and the case member 40, to the protective substrate 30.

Further, the case member 40 is provided with an opening portion 43 communicating with the coupling port 32 of the protective substrate 30 and through which the flexible substrate 110 is inserted. In the present embodiment, the opening portion 43 has a first opening portion 43a provided in the first case member 141, and a second opening portion 43b provided in the second case member 142. A width of the opening portion 43 in the Y-axis direction is narrower than a width of the coupling port 32 in the Y-axis direction.

It is preferable that the first case member 141 is formed of metal and the second case member 142 is formed of a resin material. By forming the first case member 141 from metal in this way, rigidity of the first case member 141 can be improved, and durability against an external force applied to the communication plate 15 in the -Z direction from an outside can be improved. Further, by forming the second case member 142 from resin, energization between a drive circuit 111 can be suppressed, at least a part of which is disposed within the second opening portion 43b, and the second case member 142, and electrical defects due to the energization between the drive circuit 111 and the second case member 142 can be suppressed. The first case member 141 may be formed of a resin material, the second case member 142 may be formed of metal, either thereof may be formed of resin, or either thereof may be formed of metal.

In such a liquid ejecting head H, by coupling flow paths of the communication plate 15 and the case member 40 in a liquid-tight manner, that is, coupling the first manifold portion 17 and the third manifold portion 42 with the adhesive 120 provided in the gap 45, the upper surface 30a of the protective substrate 30 and the lower surface 41a of the case member 40 can be abutted without being adhered. Therefore, similar to Embodiment 1 described above, even when an external force in the -Z direction is applied to the communication plate 15, movement of the protective substrate 30 in the -Z direction is restricted by the case member 40. Accordingly, deformation of the communication plate 15 in the -Z direction can be reduced via the protective substrate 30, and cracking of the communication plate 15 can be suppressed.

In the present embodiment, the +Z direction is an example of a "first direction", the -Z direction is an example of a "second direction", and the Y-axis direction is an example of a "third direction". The case member 40 is an example of a "case", and the communication plate 15 is an example of a "flow path substrate". That is, the flow path substrate refers to a part in the +Z direction from the gap 45. Further, the first manifold portion 17 is an example of a "first flow path", and the third manifold portion 42 is an example of a "second flow path".

The pressure chamber substrate 10 and the diaphragm 50 are examples of a "flow path forming substrate". Further, the first case member 141 is an example of a "first case", and the second case member 142 is an example of a "second case".

### Modification Example 1

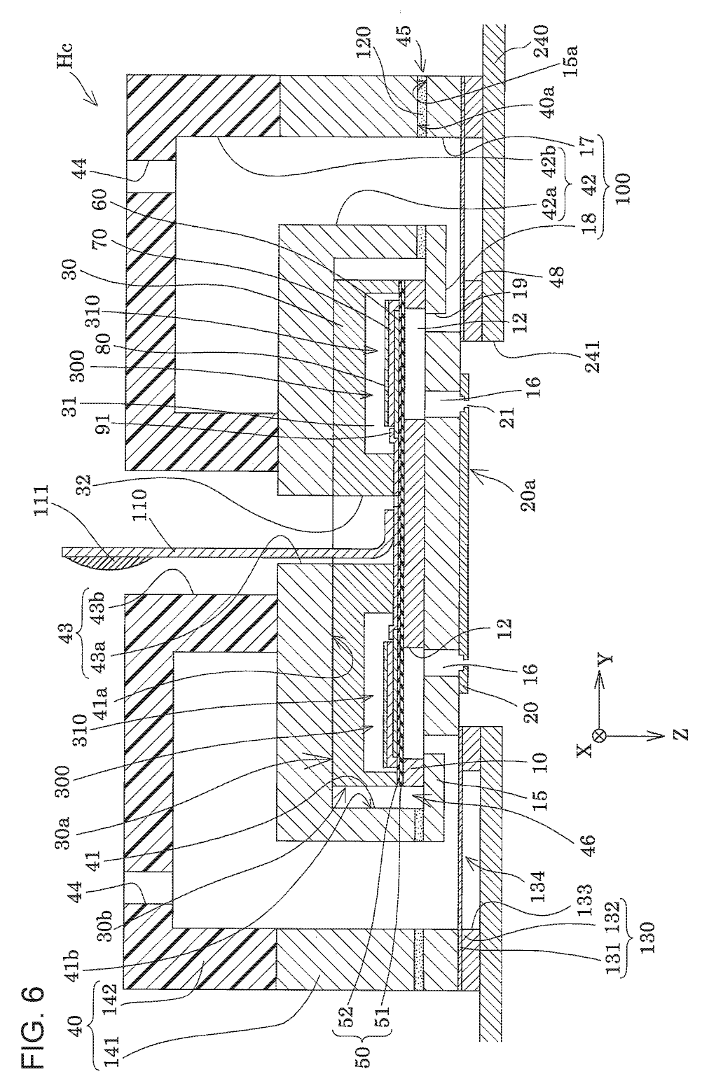

FIG. 6 is a cross-sectional view of a main part of the head chip Hc and the fixing plate 240 illustrating Modification Example 1 of the liquid ejecting head H according to Embodiment 2 of the present disclosure. As illustrated in FIG. 6, a width of the first opening portion 43a of the first case member 141 in the Y-axis direction is narrower than a width of the second opening portion 43b of the second case member 142 in the Y-axis direction. That is, a dimension of the first opening portion 43a in the Y-axis direction is narrower than a dimension of the second opening portion 43b in the Y-axis direction. In the present embodiment, the dimension of the first opening portion 43a in the Y-axis direction is substantially the same as a dimension of the coupling port 32 of the protective substrate 30 in the Y-axis direction.

By narrowing the width of the first opening portion 43a in the Y-axis direction compared to the second opening portion 43b in this way, it is easier for the protective substrate 30 to further restrict movement of a central portion of the communication plate 15 in the Y-axis direction in the -Z direction, and thus deformation of the communication plate 15 can be further reduced, and cracking of the communication plate 15 due to the deformation can be suppressed.

Further, in Modification Example 1, the width of the second opening portion 43b in the Y-axis direction is wider than a width of the coupling port 32 of the protective substrate 30 in the Y-axis direction. That is, the dimension of the second opening portion 43b in the Y-axis direction is larger than the dimension of the coupling port 32 of the protective substrate 30 in the Y-axis direction. At least a part of the drive circuit 111 mounted on the flexible substrate 110 is disposed within the second opening portion 43b.

By making the dimension of the second opening portion 43b larger than the dimension of the coupling port 32 of the protective substrate 30 in this way, contact can be suppressed between the drive circuit 111, which is disposed within the second opening portion 43b, and the second case member 142, and damage to the drive circuit 111 or disconnection of wiring due to the contact can be suppressed between the drive circuit 111 and the second case member 142. Also, by making the dimension of the second opening portion 43b larger than the dimension of the coupling port 32, it is easier to insert the flexible substrate 110 into the second opening portion 43b, facilitating assembly.

Further, it is preferable that the first case member 141 is formed of metal and the second case member 142 is formed of a resin material. By forming the first case member 141 from metal in this way, rigidity of the first case member 141 can be improved, and durability against an external force applied to the communication plate 15 in the -Z direction from an outside can be improved. Further, by forming the second case member 142 from resin, energization between the drive circuit 111 and the second case member 142 can be suppressed, and electrical defects due to the energization between the drive circuit 111 and the second case member 142 can be suppressed.

### Modification Example 2

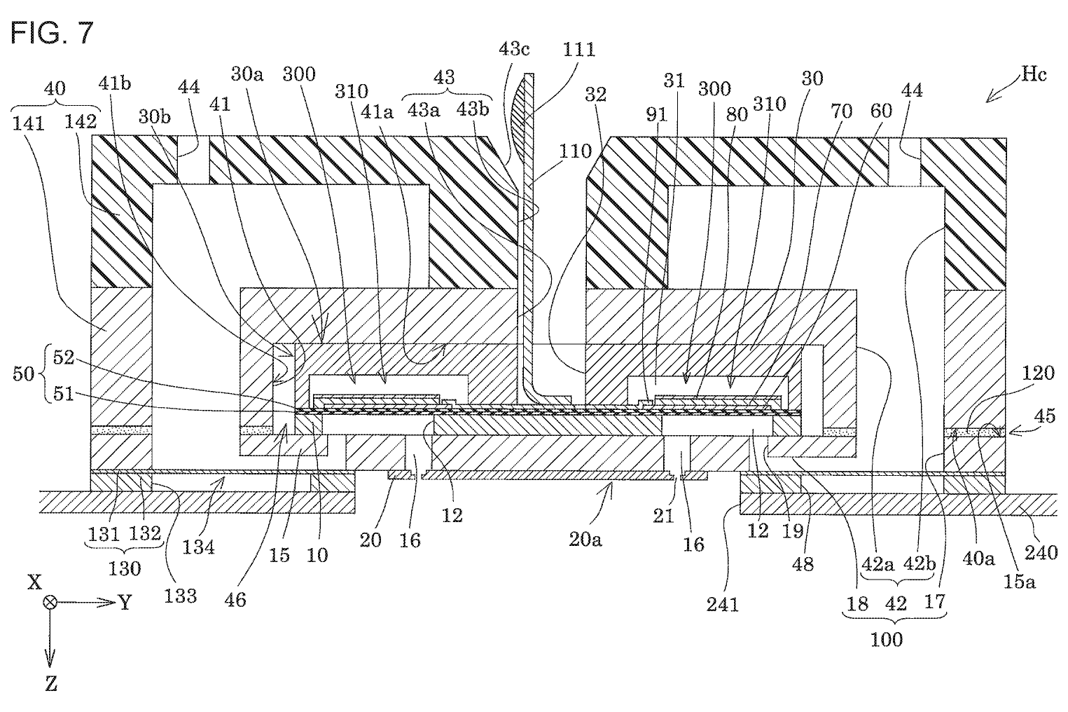

FIG. 7 is a cross-sectional view of a main part of the head chip Hc and a fixing plate 240 illustrating Modification Example 2 of the liquid ejecting head H according to Embodiment 2 of the present disclosure. As illustrated in FIG. 7, the width of the first opening portion 43a of the first case member 141 in the Y-axis direction is narrower than the width of the opening portion 43 of Embodiment 2 in the Y-axis direction, similar to Modification Example 1 described above. Further, the width of the second opening portion 43b of the second case member 142 in the Y-axis direction is narrower than the width of the opening portion 43 of Embodiment 2 described above in the Y-axis direction, and is substantially the same as the width of the first opening portion 43a. Here, "substantially the same width" means that the width of the second opening portion 43b in the Y-axis direction is within ±10% of the width of the first opening portion 43a.

By narrowing the width of the second opening portion 43b in the Y-axis direction in addition to the first opening portion 43a in this way, movement of a central portion of the communication plate 15 in the Y-axis direction in the -Z direction can be further restricted by the first case member 141 and the second case member 142. Therefore, deformation of the communication plate 15 can be further reduced, and cracking of the communication plate 15 due to the deformation can be further suppressed. Further, by making the dimension of the second opening portion 43b in the Y-axis direction relatively narrow, the second part 42b can be formed relatively large in the Y-axis direction while ensuring a thickness of the second case member 142 in the Y-axis direction between the second part 42b and the second opening portion 43b.

Further, in Modification Example 2, the opening portion 43 has a first expanded width portion 43c at an end portion in the -Z direction, a width of which in the Y-axis direction is larger than a width at a narrowest part of the opening portion 43 in the Y-axis direction. In the present embodiment, the first expanded width portion 43c is provided at an end portion of the second opening portion 43b in the -Z direction. Further, the first expanded width portion 43c has a tapered shape in which the width in the Y-axis direction increases as the part extends toward the -Z direction. That is, inner peripheral surfaces on both sides of the first expanded width portion 43c in the Y-axis direction are inclined surfaces inclined with respect to the Z-axis direction. By providing the first expanded width portion 43c in this way, after joining the case member 40 and an assembly of the pressure chamber substrate 10, the protective substrate 30, and the communication plate 15, when inserting the flexible substrate 110 into the opening portion 43 and coupling the flexible substrate 110 to a lead electrode 90, it is easier to insert the flexible substrate 110 from an opening side of the second opening portion 43b where the first expanded width portion 43c is provided, thus facilitating assembly. Further, by providing the tapered first expanded width portion 43c, the second part 42b can be formed relatively large in the Y-axis direction while ensuring a thickness of the second case member 142 in the Y-axis direction between the second part 42b and the second opening portion 43b.

Further, at least a part of the drive circuit 111 mounted on the flexible substrate 110 is disposed within the first expanded width portion 43c. By disposing at least a part of the drive circuit 111 within the first expanded width portion 43c in this way, contact can be suppressed between the drive circuit 111, which is disposed within the first expanded width portion 43c, and the second case member 142, and damage to the drive circuit 111 or disconnection of wiring due to the contact can be suppressed between the drive circuit 111 and the second case member 142.

Further, it is preferable that the first case member 141 is formed of metal and the second case member 142 is formed of a resin material. By forming the first case member 141 from metal in this way, rigidity of the first case member 141 can be improved, and durability against an external force applied to the communication plate 15 in the -Z direction from an outside can be improved. Further, by forming the second case member 142 from resin, energization between the drive circuit 111 and the second case member 142 can be suppressed, and electrical defects due to the energization between the drive circuit 111 and the second case member 142 can be suppressed.

In Modification Example 2, the first expanded width portion 43c having a tapered shape with an inclined inner peripheral surface is provided, but the present disclosure is not particularly limited thereto, and may be a tapered shape having a curved surface whose inner peripheral surface is curved. Further, the first expanded width portion 43c may have a stepped shape in which the width in the Y-axis direction widens in stages, or may have a mixture of tapered parts and stepped parts. For example, the first expanded width portion 43c may have a tapered part and a straight-shaped part having the same width in the Z-axis direction on an end portion side in the -Z direction from the tapered part. By the way, an end portion in the -Z direction of the opening portion 43 refers to a portion located in the -Z direction from a center of the opening portion 43 in the Z-axis direction. Further, the first expanded width portion 43c may be a stepped shape where the width in the Y-axis direction widens by only one stage with respect to the second opening portion 43b at an end portion in the -Z direction of the second opening portion 43b, instead of a stepped shape where the width in the Y-axis direction widens in multiple stages.

### Modification Example 3

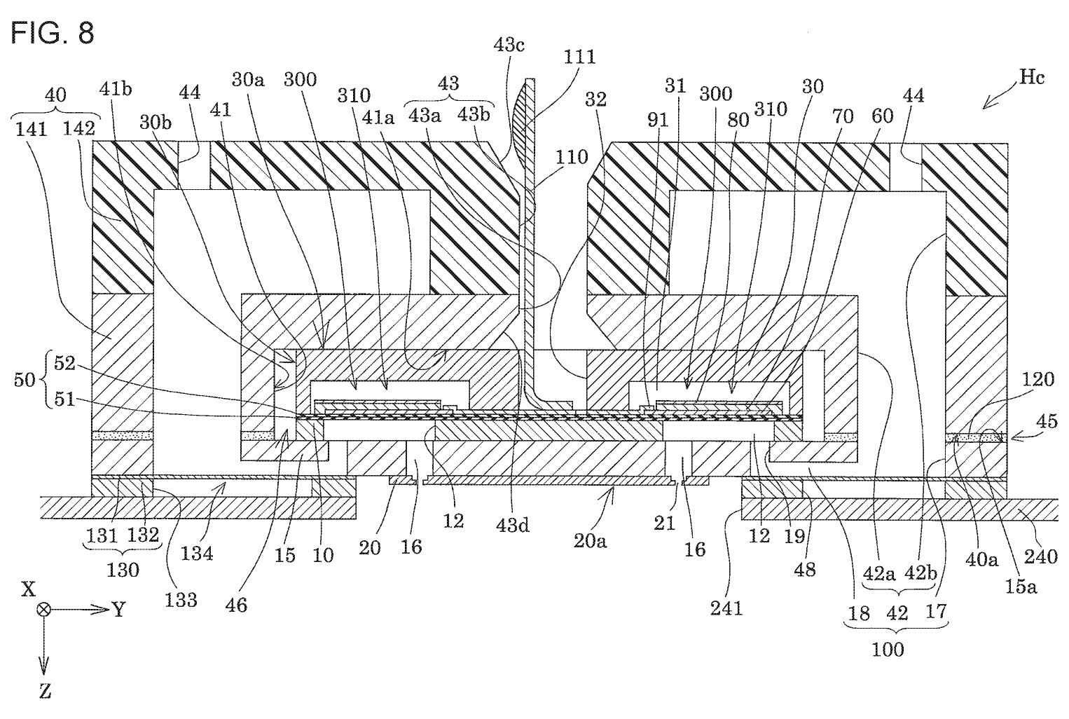

FIG. 8 is a cross-sectional view of a main part of the head chip Hc and the fixing plate 240 illustrating Modification Example 3 of the liquid ejecting head according to Embodiment 2. As illustrated in FIG. 8, the width of the first opening portion 43a of the first case member 141 in the Y-axis direction is narrower than the width of the opening portion 43 of Embodiment 2 in the Y-axis direction, similar to Modification Example 1 described above. Further, the width of the second opening portion 43b of the second case member 142 in the Y-axis direction is narrower than the width of the opening portion 43 of Embodiment 2 described above in the Y-axis direction, and is substantially the same as the width of the first opening portion 43a.

Further, the same first expanded width portion 43c as in Modification Example 2 is provided at an end portion of the opening portion 43 in the -Z direction. Also, an end portion of the opening portion 43 in the +Z direction has the second expanded width portion 43d.

The second expanded width portion 43d has a tapered shape in which the width in the Y-axis direction increases as the part extends toward the +Z direction. That is, inner peripheral surfaces on both sides of the second expanded width portion 43d in the Y-axis direction are inclined surfaces inclined with respect to the Z-axis direction. By providing the second expanded width portion 43d in this way, when joining the case member 40 and an assembly of the pressure chamber substrate 10, the protective substrate 30, and the communication plate 15 to which the flexible substrate 110 is coupled, it is easier to insert the flexible substrate 110 from an opening side of the surface of the opening portion 43 facing the +Z direction, that is, from the second expanded width portion 43d side, thereby facilitating assembly. Further, by providing the tapered second expanded width portion 43d, rigidity of the first case member 141 against an external force in the +Z direction can be improved.

In Modification Example 3, the second expanded width portion 43d having a tapered shape with an inclined inner peripheral surface is provided, but the present disclosure is not particularly limited thereto, and may be a tapered shape having a curved surface whose inner peripheral surface is curved. Further, the second expanded width portion 43d may have a stepped shape in which the width in the Y-axis direction widens in stages, or may have a mixture of tapered parts and stepped parts. For example, the second expanded width portion 43d may have a tapered part and a straight-shaped part having the same width in the Z-axis direction on an end portion side in the +Z direction from the tapered part. By the way, an end portion in the +Z direction of the opening portion 43 refers to a portion located in the -Z direction from a center of the opening portion 43 in the Z-axis direction. Further, the second expanded width portion 43d may be a stepped shape where the width in the Y-axis direction widens by only one stage with respect to the first opening portion 43a at an end portion in the +Z direction of the first opening portion 43a, instead of a stepped shape where the width in the Y-axis direction widens in multiple stages.

In Modification Example 3, the first expanded width portion 43c is provided, but the present disclosure is not particularly limited to thereto, and the first expanded width portion 43c may not be provided. Further, the same expanded width portion as the first expanded width portion 43c may be provided at an end portion of the first opening portion 43a of the first case member 141 in the -Z direction. Further, the same expanded width portion as the second expanded width portion 43d may be provided at an end portion of the second opening portion 43b of the second case member 142 in the +Z direction. By providing the expanded width portion, it is easier to insert the flexible substrate 110 from a surface side where the expanded width portion opens, thereby facilitating assembly.

### Embodiment 3

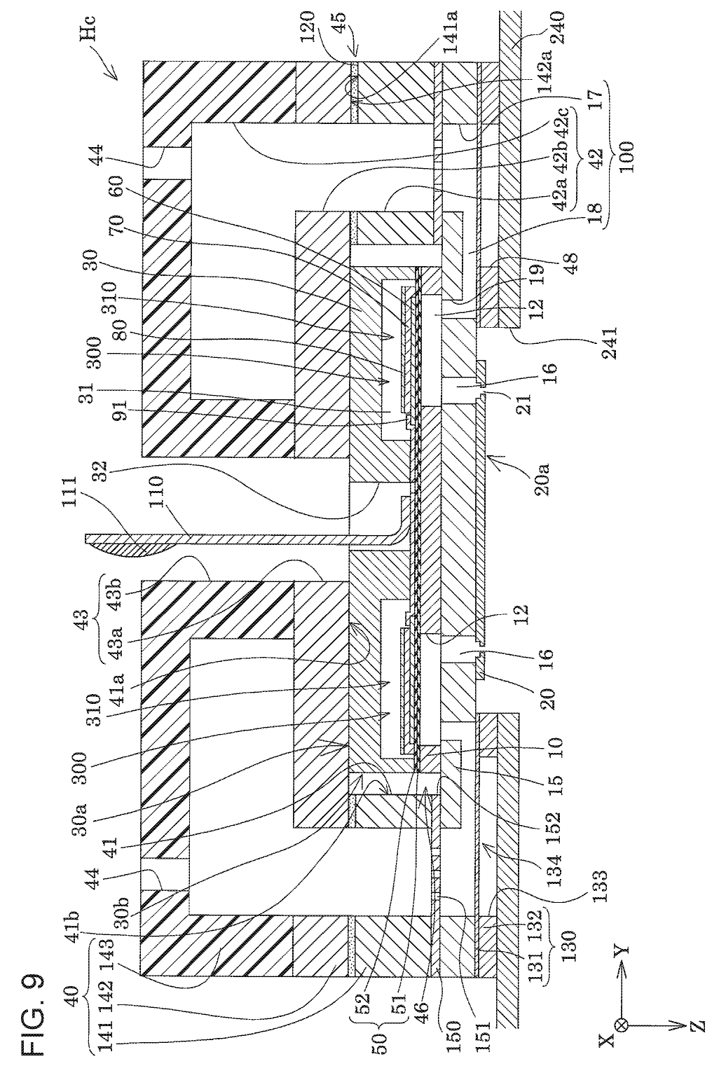

FIG. 9 is a cross-sectional view of a main part of the head chip Hc and the fixing plate 240 of a liquid ejecting head H according to Embodiment 3 of the present disclosure. Members that are the same as those in the above-described embodiment are denoted by the same reference numerals, and redundant descriptions are omitted.

As illustrated in FIG. 9, the head chip Hc of the liquid ejecting head H of the present embodiment includes the case member 40. The case member 40 includes the first case member 141, the second case member 142, and a third case member 143. The first case member 141, the second case member 142, and the third case member 143 are laminated in the -Z direction in this order.

The first case member 141 is disposed in the +Z direction from a surface of the protective substrate 30 facing the -Z direction. The second case member 142 and the third case member 143 are disposed in the -Z direction from the surface of the protective substrate 30 facing the -Z direction.

The case member 40 is provided with a third manifold portion 42. In the present embodiment, the third manifold portion 42 includes the first part 42a provided in the first case member 141, the second part 42b provided in the second case member 142, and a third part 42c provided in the third case member 143.

The first part 42a is provided to penetrate the first case member 141 in the Z-axis direction.

The second part 42b is provided to penetrate the second case member 142 in the Z-axis direction at a position overlapping the first part 42a when viewed in the Z-axis direction.

The third part 42c has a recessed shape that opens on the surface of the third case 143 facing the +Z direction. Also, the third part 42c is provided over a position where a part of the third part 42c overlaps the second part 42b and a part overlaps the protective substrate 30 when viewed in the Z-axis direction. Further, the third case member 143 is provided with the inlet 44 communicating with the third part 42c.

The first case member 141 and the filter 150, and the filter 150 and the communication plate 15 are adhered by an adhesive (not illustrated) without a gap provided therebetween. By adhering the first case member 141 and the filter 150, and between the filter 150 and the communication plate 15 without providing a gap therebetween in this way, ink leakage due to a decrease in adhesiveness can be suppressed, compared to a case where a gap is provided.

The +Z direction facing surface of the first case member 141 of such a case member 40 is joined to the surface of the communication plate 15 facing the -Z direction where the first manifold portion 17 opens via the filter 150.

Here, an outer shape of the filter 150 in the present embodiment has substantially the same shape as an outer shape of the communication plate 15 in a plan view when viewed in the +Z direction. Further, the filter 150 has a filter opening portion 152 in which a region facing the pressure chamber substrate 10 is removed over the Z-axis direction. The filter 150 is provided on the surface of the communication plate 15 facing the -Z direction with the pressure chamber substrate 10 disposed inside the filter opening portion 152.

The filter 150 is provided with a plurality of filter holes 151 in a region facing the first manifold portion 17 in a plan view when viewed in the +Z direction.

The filter 150 is an electroformed filter made of a metal plate such as Ni or Pd-Ni. The filter hole 151 is a through-hole penetrating the filter 150 in the Z-axis direction. The filter hole 151 has a circular opening when viewed in a plan view in the Z-axis direction. It is needless to say that a shape of the filter hole 151 is not limited to a circle. The filter 150 may be a laminated body of a plurality of substrates.

Further, a first surface 141a of the first case member 141 facing the -Z direction where the first part 42a of the first case member 141 opens, and a second surface 142a of the second case member 142 facing the +Z direction where the second part 42b of the second case member 142 opens, are disposed with the gap 45 in the Z-axis direction. The "gap" in the present embodiment is similar to "gap" in Embodiment 1 described above.

The first surface 141a of the first case member 141 and the second surface 142a of the second case member 142 are adhered to each other via the adhesive 120. That is, the first part 42a and the second part 42b are communicated with each other in a liquid-tight manner by the adhesive 120 disposed in the gap 45 between the first surface 141a and the second surface 142a. Such an adhesive 120 uses the same type of adhesive as the adhesive 120 disposed in the gap 45 between the communication plate 15 and the case member 40 of Embodiment 1 described above.

Further, the case member 40 has the recessed portion 41 similar to Embodiment 1 described above. The recessed portion 41 is defined by the inner peripheral surface 41b of the first case member 141 and the lower surface 41a of the second case member 142 facing the +Z direction. The lower surface 41a of the case member 40, which is the bottom surface facing the +Z direction among inner surfaces of the recessed portion 41 and is the lower surface 41a of the second case member 142 facing the +Z direction, and the upper surface 30a of the protective substrate 30 facing the -Z direction, are provided in contact with each other without being adhered.

Further, the case member 40 is provided with an opening portion 43 communicating with the coupling port 32 of the protective substrate 30 and through which the flexible substrate 110 is inserted. The opening portion 43 penetrates the case member 40 in the Z-axis direction, that is, the opening portion 43 is provided to open on the surface of the case member 40 facing the -Z direction and on the lower surface 41a of the recessed portion 41 on the -Z direction side. The flexible substrate 110 coupled to the individual lead electrode 91 and the common lead electrode 92 on the pressure chamber substrate 10 is led out to the surface side of the liquid ejecting head H facing the -Z direction via the opening portion 43. The opening portion 43 has a width in the Y-axis direction larger than that of the coupling port 32 of the protective substrate 30 when viewed in the +Z direction.

It is preferable that such the second case member 142 is formed of metal and the third case member 143 is formed of a resin material. By forming the second case member 142 from metal in this way, rigidity of the second case member 142 can be improved, and durability against an external force applied to the communication plate 15 in the -Z direction from an outside can be improved. Further, by forming the third case member 143 from resin, energization between a drive circuit 111 and the third case member 143 can be suppressed, and electrical defects due to the energization between the drive circuit 111 and the third case member 143 can be suppressed. By the way, the first case member 141 may be formed of resin, or may be formed of metal.

In such a liquid ejecting head H, by coupling the flow paths of the first case member 141 and the second case member 142 in a liquid-tight manner, that is, coupling the flow paths of the first part 42a and the second part 42b with the adhesive 120 provided in the gap 45, the lower surface 41a of the case member 40 and the upper surface 30a of the protective substrate 30 can be abutted without being adhered. Therefore, similar to Embodiment 1 described above, even when an external force in the -Z direction is applied to the communication plate 15, movement of the protective substrate 30 in the -Z direction is restricted by the case member 40. Accordingly, deformation of the communication plate 15 in the -Z direction can be reduced via the protective substrate 30, and cracking of the communication plate 15 can be suppressed.

Further, in the present embodiment, the outer peripheral surface 30b of the pressure chamber substrate 10 and the protective substrate 30, that is, an end surface of the pressure chamber substrate 10 and the protective substrate 30 along the Z-axis direction, is surrounded by an inner peripheral surface of the recessed portion 41 of the case member 40, that is, the inner peripheral surface 41b of the first case member 141, and the inner peripheral surface 41b of the recessed portion 41 of the case member 40 and the outer peripheral surface 30b of the pressure chamber substrate 10 and the protective substrate 30 are disposed with the gap 46 along the XY plane defined by the X-axis and the Y-axis. Here, it is preferable that the gap 46 between the inner peripheral surface 41b of the case member 40 and the outer peripheral surface 30b of the pressure chamber substrate 10 and the protective substrate 30 is larger than the gap 45 between the first surface 141a of the first case member 141 and the second surface 142a of the second case member 142 described above. This makes it difficult for the adhesive 120 disposed in the gap 45 between the first surface 141a of the first case member 141 and the second surface 142a of the second case member 142 to be disposed continuously between the inner peripheral surface 41b and the outer peripheral surface 30b even when the adhesive 120 flows out into the gap 46, and adhesion between the case member 40 and the protective substrate 30 can be suppressed. Therefore, by not adhering the case member 40 and the protective substrate 30, damage to the piezoelectric actuator 300 can be suppressed without transmitting an influence of deformation of the case member 40, which is caused by the difference in linear expansion coefficients between the protective substrate 30 and the case member 40, to the protective substrate 30.

In the present embodiment, the +Z direction is an example of a "first direction", the -Z direction is an example of a "second direction", and the Y-axis direction is an example of a "third direction". Further, the second case member 142 and the third case member 143 are an example of a "case", and a filter 150 and two substrates sandwiching the filter 150, that is, a communication plate 15 and the first case member 141, are an example of a "flow path substrate". That is, the flow path substrate refers to a part in the +Z direction from the gap 45. Further, the inner peripheral surface 41b is an example of "an inner peripheral surface of the flow path substrate". Also, the first part 42a is an example of a "first flow path", and the second part 42b is an example of a "second flow path". The pressure chamber substrate 10 and the diaphragm 50 are examples of a "flow path forming substrate".

### Embodiment 4

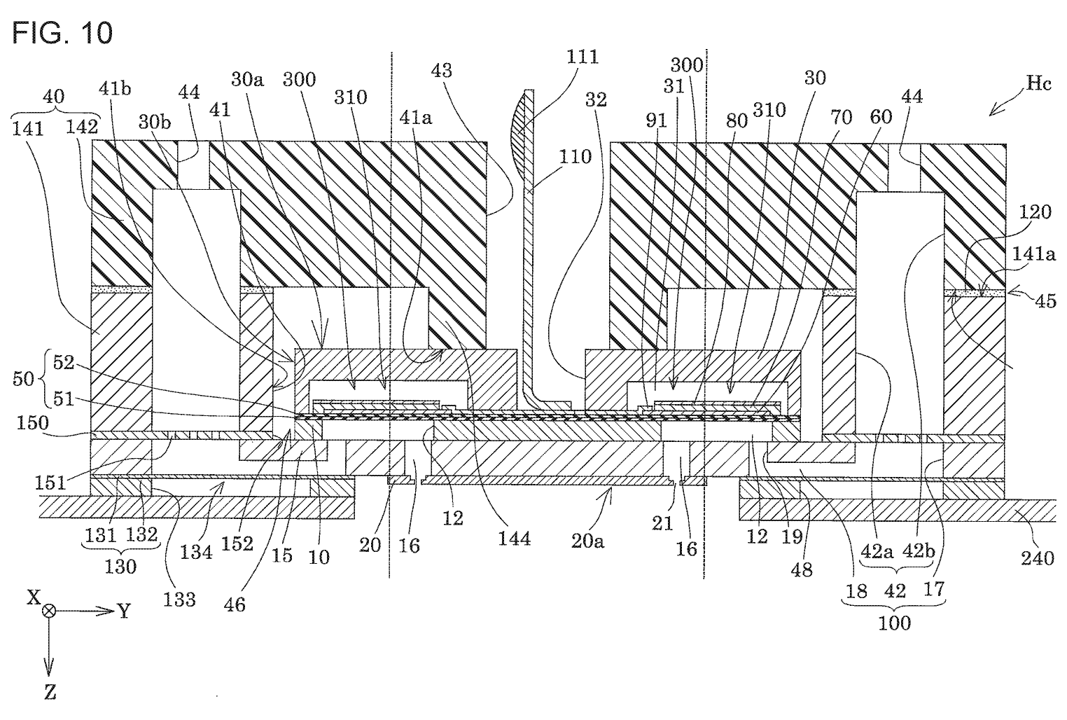

FIG. 10 is a cross-sectional view of a main part of the head chip Hc and the fixing plate 240 of a liquid ejecting head H according to Embodiment 4 of the present disclosure. Members that are the same as those in the above-described embodiment are denoted by the same reference numerals, and redundant descriptions are omitted.

As illustrated in FIG. 10, the head chip Hc of the liquid ejecting head H of the present embodiment includes the case member 40. The case member 40 includes the first case member 141 and the second case member 142. The first case member 141 and the second case member 142 are laminated in the -Z direction in this order.

The case member 40 is provided with a third manifold portion 42. In the present embodiment, the third manifold portion 42 includes a first part 42a provided on the first case member 141, and a second part 42b provided on the second case member 142.

The first part 42a is provided to penetrate the first case member 141 in the Z-axis direction.

The second part 42b has a recessed shape that is provided to open on the surface of the second case member 142 facing the +Z direction at a position overlapping the first part 42a when viewed in the Z-axis direction.

The +Z direction facing surface of the first case member 141 of such a case member 40 is joined to the surface of the communication plate 15 facing the -Z direction where the first manifold portion 17 opens via the filter 150. The filter 150 is similar to that of Embodiment 3 described above, so redundant descriptions are omitted.

Further, the first surface 141a of the first case member 141 facing the -Z direction where the first part 42a opens, and the second surface 142a of the second case member 142 facing the +Z direction where the second part 42b opens, are disposed with the gap 45 in the Z-axis direction. The "gap" in the present embodiment is similar to "gap" in Embodiment 1 described above.

The first surface 141a of the first case member 141 and the second surface 142a of the second case member 142 are adhered to each other via the adhesive 120. That is, the first part 42a and the second part 42b are communicated with each other in a liquid-tight manner by the adhesive 120 disposed in the gap 45 between the first surface 141a and the second surface 142a. Such an adhesive 120 uses the same type of adhesive as the adhesive 120 disposed in the gap 45 between the communication plate 15 and the case member 40 of Embodiment 1 described above.

Further, the second case member 142 has a convex portion 144 protruding in the +Z direction. The lower surface 41a of the case member 40 facing the +Z direction and the upper surface 30a of the protective substrate 30 facing the -Z direction are provided in contact with each other without being adhered. In the present embodiment, the lower surface 41a of the case member 40 is a tip end surface of the convex portion 144 in +Z direction.

Further, in the present embodiment, when viewed in the +Z direction, the lower surface 41a, which is the end surface of the convex portion 144 in the +Z direction, and the upper surface 30a of the protective substrate 30 facing the -Z direction are in contact at a position inward of a center position (indicated by the broken line in FIG. 10) between an inner peripheral surface of the coupling port 32 of the protective substrate 30 and an outer peripheral surface 30b of the protective substrate 30.

Further, the case member 40 is provided with an opening portion 43 communicating with the coupling port 32 of the protective substrate 30 and through which the flexible substrate 110 is inserted. The opening portion 43 penetrates the case member 40 in the Z-axis direction, that is, the opening portion 43 is provided to open on the surface of the case member 40 facing the -Z direction and on the lower surface 41a of the recessed portion 41 on the -Z direction side. The flexible substrate 110 coupled to the individual lead electrode 91 and the common lead electrode 92 on the pressure chamber substrate 10 is led out to the surface side of the liquid ejecting head H facing the -Z direction via the opening portion 43. The opening portion 43 has a width in the Y-axis direction larger than that of the coupling port 32 of the protective substrate 30 when viewed in the +Z direction.

It is preferable that such a first case member 141 is formed of metal and the second case member 142 is formed of a resin material. By forming the first case member 141 from metal in this way, rigidity of the first case member 141 can be improved, and durability against an external force applied to the communication plate 15 in the -Z direction from an outside can be improved. Further, by forming the second case member 142 from resin, energization between the drive circuit 111 and the second case member 142 can be suppressed, and electrical defects due to the energization between the drive circuit 111 and the second case member 142 can be suppressed.

In such a liquid ejecting head H, by coupling the flow paths of the first case member 141 and the second case member 142 in a liquid-tight manner, that is, coupling the flow paths of the first part 42a and the second part 42b with the adhesive 120 provided in the gap 45, the lower surface 41a of the case member 40 and the upper surface 30a of the protective substrate 30 can be abutted without being adhered. Therefore, similar to Embodiment 1 described above, even when an external force in the -Z direction is applied to the communication plate 15, movement of the protective substrate 30 in the -Z direction is restricted by the case member 40. Accordingly, deformation of the communication plate 15 in the -Z direction can be reduced via the protective substrate 30, and cracking of the communication plate 15 can be suppressed.

Further, in the present embodiment, the lower surface 41a, which is the end surface of the convex portion 144 in the +Z direction, and the upper surface 30a of the protective substrate 30 facing the -Z direction are in contact at a position inward of a center position between an inner peripheral surface of the coupling port 32 of the protective substrate 30 and an outer peripheral surface of the protective substrate 30 when viewed in the +Z direction, thereby facilitating flattening of the lower surface 41a, which is an end surface of the convex portion 144. Therefore, a pressure-receiving area that receives an external force of the case member 40 can be increased. Further, even when an area of the lower surface 41a, which is an end surface of the convex portion 144 that pushes the upper surface 30a of the protective substrate 30 facing the -Z direction, is relatively small, a largely deformed central part is suppressed by the lower surface 41a, which is the end surface of the convex portion 144, so deformation of the communication plate 15 can be effectively suppressed.

Further, in the present embodiment, the outer peripheral surface 30b of the pressure chamber substrate 10 and the protective substrate 30 is surrounded by the inner peripheral surface 41b of the first case member 141, and the inner peripheral surface 41b of the case member 40 and the outer peripheral surface 30b of the pressure chamber substrate 10 and the protective substrate 30 are disposed with the gap 46 along the XY plane defined by the X-axis and the Y-axis. Here, it is preferable that the gap 46 between the inner peripheral surface 41b of the case member 40 and the outer peripheral surface 30b of the pressure chamber substrate 10 and the protective substrate 30 is larger than the gap 45 between the first surface 141a of the first case member 141 and the second surface 142a of the second case member 142 described above. As a result, even when the adhesive 120 disposed in the gap 45 between the first surface 141a of the first case member 141 and the second surface 142a of the second case member 142 flows out into the gap 46 between the inner peripheral surface 41b and the outer peripheral surface 30b, it is difficult for the adhesive 120 to be disposed continuously between the inner peripheral surface 41b and the outer peripheral surface 30b, and adhesion between the case member 40 and the protective substrate 30 can be suppressed. Therefore, by not adhering the case member 40 and the protective substrate 30, damage to the piezoelectric actuator 300 can be suppressed without transmitting an influence of deformation of the case member 40, which is caused by the difference in linear expansion coefficients between the protective substrate 30 and the case member 40, to the protective substrate 30.

Further, since the convex portion 144 contacting the protective substrate 30 is provided on the second case member 142, and the case member 40 is divided into the first case member 141 and the second case member 142, the gap 45 is provided between the first case member 141 and the second case member 142 to adhere therebetween. This eliminates the need to form a gap between the filter 150 and the first case member 141, and adhesiveness of the filter 150 to the first case member 141 can be improved.

In the present embodiment, the +Z direction is an example of a "first direction", the -Z direction is an example of a "second direction", and the Y-axis direction is an example of a "third direction". Further, the second case member 142 is an example of a "case", and a filter 150 and two substrates sandwiching the filter 150, that is, a communication plate 15 and the first case member 141, are an example of a "flow path substrate". That is, the flow path substrate refers to a part in the +Z direction from the gap 45. Further, the inner peripheral surface 41b is an example of "an inner peripheral surface of the flow path substrate". Also, the first part 42a is an example of a "first flow path", and the second part 42b is an example of a "second flow path". The pressure chamber substrate 10 and the diaphragm 50 are examples of a "flow path forming substrate".

### Other Embodiments

The embodiments of the present disclosure have been described above, but a basic configuration of the present disclosure is not limited to those described above.

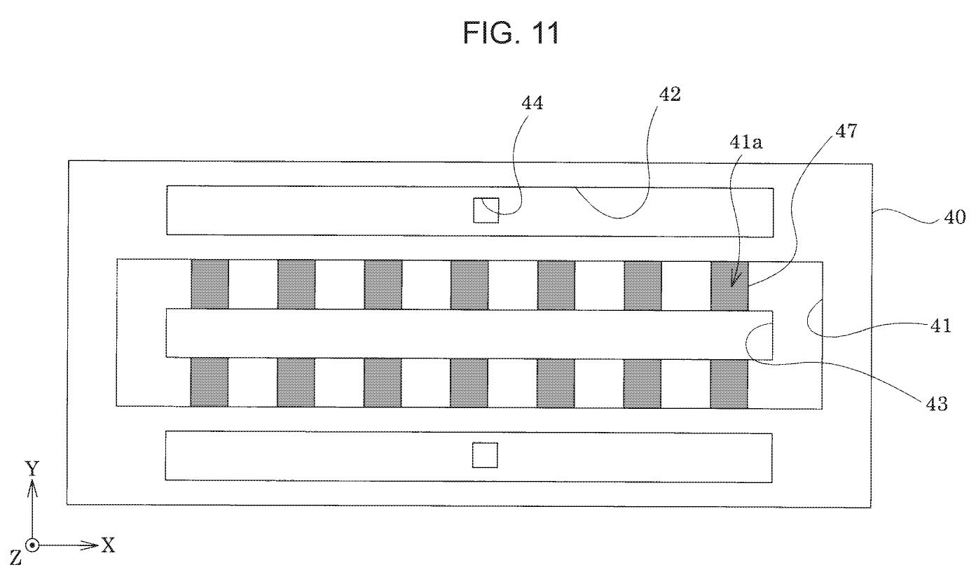

For example, in each of the embodiments described above, the upper surface 30a of the protective substrate 30 facing the -Z direction and the lower surface 41a of the case member 40 facing the +Z direction are flat surfaces, but the present disclosure is not particularly limited thereto. Here, a modification example of the case member 40 of Embodiment 1 is illustrated in FIG. 11. FIG. 11 is a plan view of the case member 40 according to another embodiment when viewed in the -Z direction. In FIG. 11, the protrusion portion 47 and the lower surface 41a are illustrated in black.

As illustrated in FIG. 11, a plurality of protrusion portions 47 are provided in the gap on the bottom surface of the recessed portion 41 of the case member 40. The tip end surface of the plurality of protrusion portions 47 in the +Z direction is the lower surface 41a, and this lower surface 41a contacts the upper surface 30a of the protective substrate 30 facing the -Z direction without being adhered. That is, the lower surface 41a is divided into a plurality of parts by recessed portions provided between the plurality of protrusion portions 47. In such a configuration, surface accuracy by flattening end surfaces of the plurality of protrusion portions 47 can be improved, compared to flattening the entire bottom surface of the recessed portion 41. Therefore, the tip end surfaces of the plurality of protrusion portions 47 can be brought into contact with the upper surface 30a of the protective substrate 30 with uniform force, thereby restricting movement of the protective substrate 30 in the -Z direction and suppressing deformation of the communication plate 15.

In the example illustrated in FIG. 11, a modification example of the case member 40 of Embodiment 1 is exemplified, but the present disclosure is not particularly limited thereto, and can also be applied to the case members 40 of Embodiments 2 to 4.

Further, in FIG. 11, the lower surface 41a is divided into a plurality of parts by providing the plurality of protrusion portions 47 on the bottom surface of the recessed portion 41 of the case member 40, but the present disclosure is not particularly limited thereto. A plurality of protrusion portions protruding in the -Z direction may be provided on the upper surface 30a of the protective substrate 30 facing the -Z direction, and the tip end surfaces of the protrusion portions may be used as the upper surface 30a to contact the case member 40. That is, surface accuracy of the upper surface 30a may be improved by dividing the upper surface 30a of the protective substrate 30 into a plurality of parts. It is needless to say that both the lower surface 41a of the case member 40 and the upper surface 30a of the protective substrate 30 may be divided into a plurality of parts to improve surface accuracy of both surfaces.

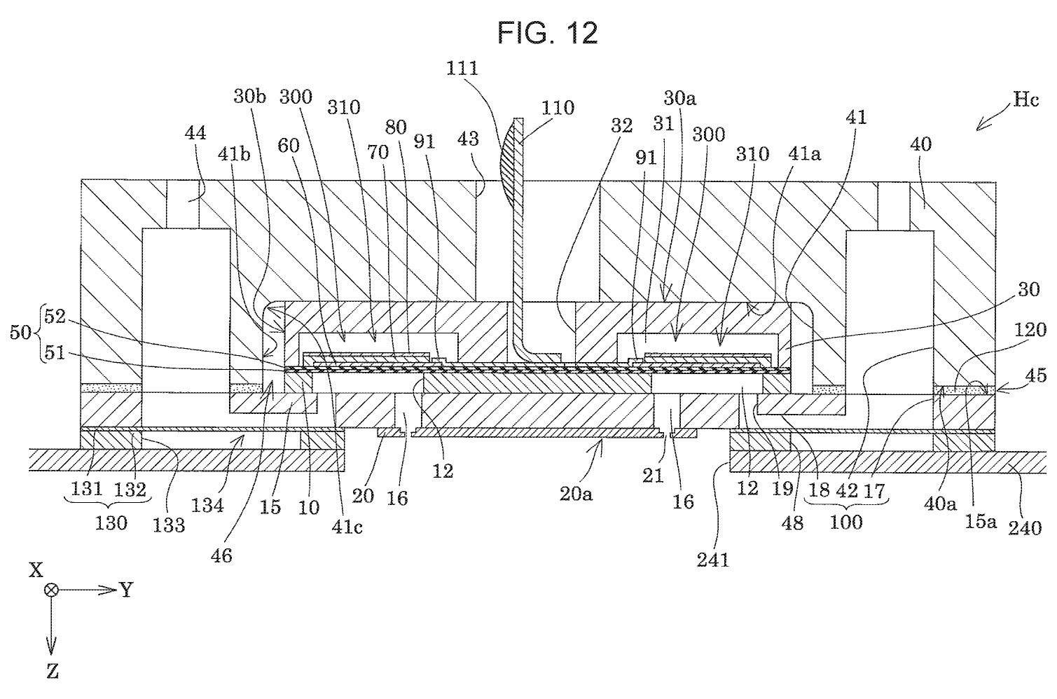

Further, the corner portion of the recessed portion 41 of the case member 40 of Embodiment 1 described above may be a curved surface. Such an example is illustrated in FIG. 12. FIG. 12 is a cross-sectional view of a main part of the head chip Hc and the fixing plate 240 illustrating a modification example of the case member 40 of Embodiment 1.

As illustrated in FIG. 12, an end portion of the recessed portion 41 of the case in the -Z direction has a shape in which the width in the Y-axis direction gradually decreases toward the -Z direction. That is, a corner portion 41c coupling the lower surface 41a of the recessed portion 41 and the inner peripheral surface 41b is a concave curved surface. By making the corner portion 41c of the recessed portion 41 a concave curved surface in this way, deformation of the case member 40 portion itself due to an external force in the -Z direction can be suppressed, and to reduce deformation of the communication plate 15 and suppress cracking of the communication plate 15. The corner portion 41c may be a convex curved surface, or an inclined surface inclined with respect to the Z-axis direction. Such a corner portion 41c can also be applied to case members 40 of Embodiments 2 to 4 described above.

Further, configurations of Modification Examples 1 to 3 of Embodiment 2 described above can also be applied to Embodiment 1, Embodiment 3, and Embodiment 4, and the same effects as in Modification Examples 1 to 3 can be obtained.

Further, in each of the embodiments described above, a thin-film piezoelectric actuator 300 was used as the drive element to generate pressure changes in the pressure chamber 12, but the present disclosure is not particularly limited thereto, and as the drive element, for example, a thick-film piezoelectric actuator formed by methods such as attaching a green sheet, or a longitudinal vibration type piezoelectric actuator that expands and contracts in the axial direction by alternately laminating a piezoelectric material and an electrode forming material, can be used. Further, as the drive element, a configuration in which a heating element is disposed in the pressure chamber 12 to eject liquid droplets from the nozzle 21 by bubbles generated by heat generation of the heating element, or a so-called electrostatic actuator that generates static electricity between a diaphragm and an electrode and deforms the diaphragm by electrostatic force to eject liquid droplets from the nozzle 21, can be used.

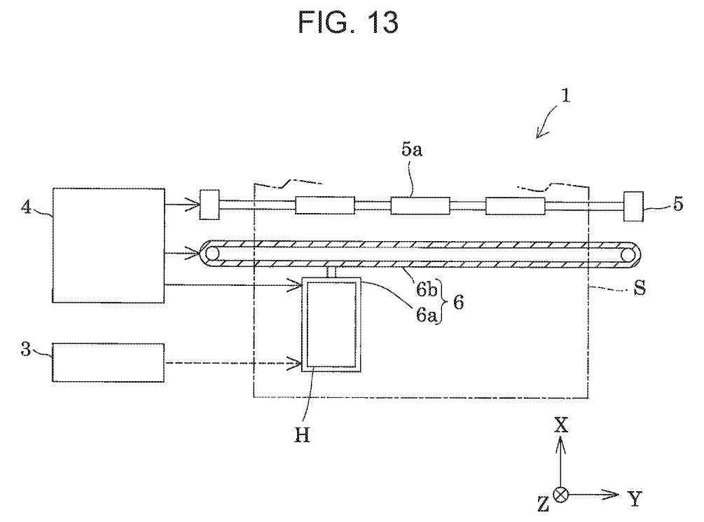

Further, the liquid ejecting head H of each embodiment is mounted on the liquid ejecting apparatus 1. FIG. 13 is a diagram illustrating a schematic configuration of the liquid ejecting apparatus 1.

As illustrated in FIG. 13, the liquid ejecting apparatus 1 is a so-called serial type printer that includes the liquid ejecting head H, transports a medium S in the X-axis direction, and performs printing by ejecting liquid from the liquid ejecting head H toward the medium S in the +Z direction while reciprocating the liquid ejecting head H in the Y-axis direction. For the medium S, any material such as recording paper, resin film, or cloth can be used.

The liquid ejecting apparatus 1 includes the liquid ejecting head H, a liquid storage portion 3, a control portion 4, a transport mechanism 5 that sends out the medium S, and a movement mechanism 6.

The liquid ejecting head H ejects liquid supplied from the liquid storage portion 3 as liquid droplets in the +Z direction.

The liquid storage portion 3 stores liquid to be ejected from the liquid ejecting head H. Examples of the liquid storage portion 3 include a cartridge detachable from the liquid ejecting apparatus 1, a bag-shaped ink pack formed of a flexible film, and an ink tank that can be replenished with ink. Although not particularly illustrated in the drawings, for example, a plurality of types of ink with different colors and components are individually stored in the liquid storage portion 3. Further, the liquid storage portion 3 may be divided into a main tank and a sub tank. A configuration in which a sub tank is coupled to the liquid ejecting head H and consumes liquid by ejecting liquid droplets from the liquid ejecting head H to replenish the sub tank from the main tank may also be used. Further, liquid may be circulated between the liquid storage portion 3 and the liquid ejecting head H.

The control portion 4 includes, for example, a control device such as a central processing unit (CPU) or a field programmable gate array (FPGA), and a storage device such as a semiconductor memory. The control portion 4 also includes a power supply device that supplies power supplied from an external power supply such as a commercial power supply to each element of the liquid ejecting apparatus 1. The control portion 4 is electrically coupled to the liquid ejecting head H via external wiring (not illustrated). The control portion 4 comprehensively controls each element of the liquid ejecting apparatus 1 by the control device executing a program stored in the storage device.

The transport mechanism 5 transports the medium S in the X-axis direction, and has, for example, a transport roller 5a that rotates by a transport motor controlled and driven by the control portion 4.

The movement mechanism 6 is a mechanism for reciprocating the liquid ejecting head H in the Y-axis direction, and includes a holder 6a that holds the liquid ejecting head H, and a transport belt 6b which is an endless belt installed along the Y-axis direction. The control portion 4 rotates the transport belt 6b by controlling driving of a transport motor (not illustrated), thereby reciprocating the liquid ejecting head H in the Y-axis direction together with the holder 6a fixed to the transport belt 6b.

The liquid ejecting head H, under control by a control portion 4, executes an ejecting operation that ejects ink supplied from the liquid storage portion 3 as liquid droplets in the +Z direction from each of the plurality of nozzles 21. This ejecting operation by the liquid ejecting head H is performed in parallel with transport of the medium S by the transport mechanism 5 and reciprocating movement of the liquid ejecting head H by the movement mechanism 6, thereby performing so-called printing where ink is applied to the medium S.

Furthermore, the present disclosure broadly targets all liquid ejecting apparatuses including a liquid ejecting head. The liquid ejecting head includes, for example, recording heads such as various ink jet recording heads used in image recording apparatuses such as printers, and color material ejecting heads used in manufacturing color filters such as liquid crystal displays. The liquid ejecting head also includes, for example, electrode material ejecting heads used for forming electrodes of organic EL displays, field emission display (FED), and the like, and biomaterial ejecting heads used for manufacturing biochips. The present disclosure can also be applied to liquid ejecting apparatuses equipped with these liquid ejecting heads.

### Addendum

From the examples illustrated above, for example, the following configurations can be understood.

According to Aspect 1, which is a preferred aspect, there is provided a liquid ejecting head including a nozzle plate having a plurality of nozzles for ejecting liquid in a first direction, a flow path substrate laminated on the nozzle plate in a second direction opposite to the first direction and having a first flow path communicating with the plurality of nozzles, a flow path forming substrate laminated on the flow path substrate in the second direction and having a pressure chamber, a drive element provided on a surface of the flow path forming substrate facing the second direction, a protective substrate laminated on the flow path forming substrate and accommodating the drive element, and a case disposed in the second direction with respect to the flow path substrate and having a second flow path communicating with the first flow path, in which a first surface of the flow path substrate that faces the second direction and on which the first flow path opens, and a second surface of the case that faces the first direction and on which the second flow path opens, are disposed in the first direction with a gap, the first flow path and the second flow path are communicated with each other in a liquid-tight manner by an adhesive disposed in the gap, and an upper surface of the protective substrate facing the second direction and a lower surface of the case facing the first direction are in contact with each other without being adhered to each other. As a result, by adhering the flow path substrate and the case with the adhesive provided in the gap, the upper surface of the protective substrate and the lower surface of the case can be brought into contact. Therefore, without adhering the case and the protective substrate, damage to the protective substrate and the drive element can be suppressed without transmitting deformation of the case, which is caused by the difference in linear expansion coefficients, to the protective substrate. Further, by bringing the upper surface of the protective substrate and the lower surface of the case into contact, movement of the protective substrate in the second direction can be restricted by the case when an external force is applied to the liquid ejecting head in the second direction. This can reduce the deformation of the flow path substrate into a convex shape in the second direction and suppress cracking of the flow path substrate.

In Aspect 2 which is a specific example of Aspect 1, an outer peripheral surface of the protective substrate is surrounded by at least one of an inner peripheral surface of the case and an inner peripheral surface of the flow path substrate and is disposed inwardly with a gap. Accordingly, the adhesive, which adheres the gap between the flow path substrate and the case, can be suppressed from flowing out into the gap between the inner peripheral surface and the outer peripheral surface, and from adhering the inner peripheral surface and the outer peripheral surface. This can suppress adhesion between the case and the protective substrate, and can suppress damage to the protective substrate and damage to the drive element due to a difference in linear expansion coefficients.

In Aspect 3, which is a specific example of Aspect 1, the liquid ejecting head, further includes a flexible substrate electrically coupled to the drive element, in which the case includes a first case having the lower surface that contacts the upper surface of the protective substrate, and a second case laminated on the first case in the second direction, the first case has a first opening portion into which the flexible substrate is inserted, the second case has a second opening portion into which the flexible substrate is inserted, and in a third direction orthogonal to both a nozzle row direction in which the plurality of nozzles are disposed and the first direction, a dimension of the second opening portion is larger than a dimension of the first opening portion. Accordingly, by reducing a dimension of the first opening portion of the first case, a pressure-receiving area that restricts movement of the protective substrate in the second direction can be expanded, and deformation of the flow path substrate can be further reduced. Further, by widening the second opening portion of the second case, it is easier to insert the flexible substrate into the second opening portion.

In Aspect 4, which is a specific example of Aspect 3, the flexible substrate has a drive circuit for driving the drive element, the protective substrate has a coupling port into which the flexible substrate is inserted, in the third direction, the dimension of the second opening portion is larger than a dimension of the coupling port of the protective substrate, and at least a part of the drive circuit is disposed within the second opening portion. Accordingly, even when the flexible substrate has the drive circuit, by widening the dimension of the second opening portion, it is easy to suppress the contact between the second case and the drive circuit, and damage to the drive circuit or electrical defects due to the contact between the second case and the drive circuit can be suppressed.

In Aspect 5, which is a specific example of Aspect 4, the first case is formed of metal, and the second case is formed of resin. Accordingly, by forming the first case from metal, rigidity of the first case can be increased, and deformation of the flow path substrate can be further reduced. Further, by forming the second case from resin, it is difficult for the second case and the drive circuit to be energized, and electrical defects such as short circuits caused by the energization between the second case and drive circuit can be suppressed.

In Aspect 6, which is a specific example of Aspect 1, the liquid ejecting head further includes a flexible substrate electrically coupled to the drive element, in which the case has an opening portion into which the flexible substrate is inserted, and an end portion of the opening portion of the case in the second direction has an expanded width portion, a width of which in a third direction orthogonal to both a nozzle row direction in which the plurality of nozzles are disposed and the first direction, is larger than a width of a narrowest part of the opening portion of the case in the third direction. Accordingly, by providing the expanded width portion, even when the opening portion of the case is narrowed to expand the pressure-receiving area that restricts movement of the protective substrate in the second direction, it is easier to insert the flexible substrate into the case in the first direction. Further, by providing at least a part of the drive circuit of the flexible substrate within the expanded width portion, it is difficult for the drive circuit to contact the second case, and damage to the drive circuit or disconnection of wiring due to the contact can be suppressed.

In Aspect 7, which is a specific example of Aspect 6, the expanded width portion has a part where the width in the third direction increases as the part extends toward the second direction. Accordingly, by defining a shape of the expanded width portion, the second flow path of the case can be disposed relatively large, and it is easy to insert the flexible substrate into the opening portion of the case in the first direction.

In Aspect 8, which is a specific example of the Aspect 1, the liquid ejecting head further includes a flexible substrate electrically coupled to the drive element, in which the case has an opening portion into which the flexible substrate is inserted, and an end portion of the opening portion of the case in the first direction has an expanded width portion, a width of which in a third direction orthogonal to both a nozzle row direction in which the plurality of nozzles are disposed and the first direction, is larger than a width of a narrowest part of the opening portion of the case in the third direction. Accordingly, by providing the expanded width portion, it is easier to insert the flexible substrate into the case in the second direction.

In Aspect 9, which is a specific example of Aspect 8, the expanded width portion has a part where the width in the third direction increases as the part extends toward the first direction. Accordingly, by defining a shape of the expanded width portion, the second flow path of the case can be disposed relatively large, and it is easy to insert the flexible substrate into the opening portion of the case in the second direction.

In Aspect 10, which is a specific example of the Aspect 1, the flow path substrate includes an electroformed filter and two substrates sandwiching the electroformed filter. Accordingly, by adhering the electroformed filter, which is difficult to adhere, and the two substrates sandwiching the electroformed filter without providing the gap therebetween, a decrease in adhesiveness can be suppressed compared to a case where the gap is provided for adhesion, and liquid leakage can be suppressed.

In Aspect 11, which is a specific example of Aspect 1, the case has a convex portion protruding from the second surface in the first direction, and the lower surface of the case is provided at an end portion of the convex portion in the first direction.

In Aspect 12, which is a specific example of Aspect 11, the liquid ejecting head further includes a flexible substrate electrically coupled to the drive element, in which the protective substrate has a coupling port into which the flexible substrate is inserted, and when viewed in the first direction, the upper surface of the protective substrate and the lower surface of the case are in contact at a position inward of a center position between an inner edge of the coupling port of the protective substrate and an outer edge of the protective substrate. Accordingly, even when an area of the second surface where the case contacts the protective substrate is reduced, thereby reducing the pressure-receiving area, deformation of the flow path substrate can be effectively suppressed by restricting movement of the protective substrate at a center side where deformation is large.

In Aspect 13, which is a specific example of Aspect 1, the lower surface of the case contacting the upper surface of the protective substrate is divided into a plurality of parts. Accordingly, by dividing the lower surface into a plurality of parts, flattening of the lower surface can be improved, and weight applied to the lower surface can be evenly distributed.

According to Aspect 1, which is a preferred aspect, the liquid ejecting apparatus includes the liquid ejecting head described in any one of Aspects 1 to 13, and a liquid storage portion for storing liquid to be supplied to the liquid ejecting head. Accordingly, a liquid ejecting apparatus with a long lifespan can be realized by suppressing damage to the liquid ejecting head.

What is claimed is:

1. A liquid ejecting head comprising:
a nozzle plate having a plurality of nozzles configured to eject liquid in a first direction;
a flow path substrate laminated on the nozzle plate in a second direction opposite to the first direction and having a first flow path communicating with the plurality of nozzles;
a flow path forming substrate laminated on the flow path substrate in the second direction and having a pressure chamber;
a drive element provided on a surface of the flow path forming substrate facing the second direction;
a protective substrate laminated on the flow path forming substrate and accommodating the drive element; and
a case disposed in the second direction with respect to the flow path substrate and having a second flow path communicating with the first flow path, wherein
a first surface of the flow path substrate that faces the second direction and on which the first flow path opens, and a second surface of the case that faces the first direction and on which the second flow path opens, are disposed in the first direction with a gap,
the first flow path and the second flow path are communicated with each other in a liquid-tight manner by an adhesive disposed in the gap, and
an upper surface of the protective substrate facing the second direction and a lower surface of the case facing the first direction are in contact with each other without being adhered to each other.

2. The liquid ejecting head according to claim 1, wherein
an outer peripheral surface of the protective substrate is surrounded by at least one of an inner peripheral surface of the case and an inner peripheral surface of the flow path substrate and is disposed inwardly with a gap.

3. The liquid ejecting head according to claim 1, further comprising:
a flexible substrate electrically coupled to the drive element, wherein
the case includes a first case having the lower surface that contacts the upper surface of the protective substrate, and a second case laminated on the first case in the second direction,
the first case has a first opening portion into which the flexible substrate is inserted,
the second case has a second opening portion into which the flexible substrate is inserted, and
in a third direction orthogonal to both a nozzle row direction in which the plurality of nozzles are disposed and the first direction, a dimension of the second opening portion is larger than a dimension of the first opening portion.

4. The liquid ejecting head according to claim 3, wherein
the flexible substrate has a drive circuit for driving the drive element,
the protective substrate has a coupling port into which the flexible substrate is inserted,
in the third direction, the dimension of the second opening portion is larger than a dimension of the coupling port of the protective substrate, and
at least a part of the drive circuit is disposed within the second opening portion.

5. The liquid ejecting head according to claim 4, wherein
the first case is formed of metal, and
the second case is formed of resin.

6. The liquid ejecting head according to claim 1, further comprising:
a flexible substrate electrically coupled to the drive element, wherein
the case has an opening portion into which the flexible substrate is inserted, and
an end portion of the opening portion of the case in the second direction has an expanded width portion, a width of which in a third direction orthogonal to both a nozzle row direction in which the plurality of nozzles are disposed and the first direction, is larger than a width of a narrowest part of the opening portion of the case in the third direction.

7. The liquid ejecting head according to claim 6, wherein
the expanded width portion has a part where the width in the third direction increases as the part extends toward the second direction.

8. The liquid ejecting head according to claim 1, further comprising:
a flexible substrate electrically coupled to the drive element, wherein
the case has an opening portion into which the flexible substrate is inserted, and
an end portion of the opening portion of the case in the first direction has an expanded width portion, a width of which in a third direction orthogonal to both a nozzle row direction in which the plurality of nozzles are disposed and the first direction, is larger than a width of a narrowest part of the opening portion of the case in the third direction.

9. The liquid ejecting head according to claim 8, wherein
the expanded width portion has a part where the width in the third direction increases as the part expands toward the first direction.

10. The liquid ejecting head according to claim 1, wherein
the flow path substrate includes an electroformed filter and two substrates sandwiching the electroformed filter.

11. The liquid ejecting head according to claim 1, wherein
the case has a convex portion protruding from the second surface in the first direction, and
the lower surface of the case is provided at an end portion of the convex portion in the first direction.

12. The liquid ejecting head according to claim 11, further comprising:
a flexible substrate electrically coupled to the drive element, wherein
the protective substrate has a coupling port into which the flexible substrate is inserted, and
when viewed in the first direction, the upper surface of the protective substrate and the lower surface of the case are in contact at a position inward of a center position between an inner edge of the coupling port of the protective substrate and an outer edge of the protective substrate.

13. The liquid ejecting head according to claim 1, wherein
the lower surface of the case contacting the upper surface of the protective substrate is divided into a plurality of parts.

14. A liquid ejecting apparatus comprising:
the liquid ejecting head according to claim 1; and
a liquid storage portion for storing liquid to be supplied to the liquid ejecting head.
